(19) United States
(12) Patent Application Publication
(10) Pub. No.: US 2025/0383871 A1
(43) Pub. Date: Dec. 18, 2025

(54) PROCESSING FOR PROCESSORS PERFORMING TASKS USING PROGRAMMABLE LOOKUP TABLE

(71) Applicant: MICROSOFT TECHNOLOGY LICENSING, LLC, Redmond, WA (US)

(72) Inventors: Dushyanth BHOJARAJA, Fremont, CA (US); Dennis Clayton LOU, Los Altos, CA (US)

(21) Appl. No.: 18/744,300

(22) Filed: Jun. 14, 2024

(51) Int. Cl. G06F 9/30

(52) U.S. Cl. CPC G06F 9/3004; G06F 9/30036

(57) ABSTRACT

Various embodiments described herein control circuitry of a computing device to cause the computing device to perform an AI-based task in a numerical format different from a numerical format in which the AI-based task is received. Embodiments of the technology described herein perform certain AI-based tasks based on a programmable lookup table (PLUT) that facilitates mapping the AI-based task from a first datatype format to a second datatype format matching the datatype format of the computing device assigned to perform the AI-based task. The conversion from datatypes is performed based on an instruction that includes performing a write operation and an extract operation using the PLUT. In this manner, certain computing devices employing the PLUT perform AI-based tasks quicker, with less power waste and more computational efficiency than using conventional technology, thereby improving hardware lifespan and efficiency on a clock cycle basis.

### BACKGROUND

Performing computations, workloads, or tasks in a distributed environment, such as a “cloud computing system” or the “cloud,” generally represents a transformative paradigm in computing that leverages the power of remote data centers to perform complex computing tasks. An example of complex computing workloads or tasks includes those associated with artificial intelligence (AI). Accessibility to AI has been facilitated by the widespread adoption of the cloud, which has evolved in response to the increasing demand for computational resources that exceeds the computational resources available on individual devices running locally on-premises. Recent widespread adoption of AI-related tasks has caused the demand for computational resources provided by certain distributed environments to increase. For example, running AI-based computations includes processing raw data, initializing AI models, iteratively training the AI models, validating the AI models, deploying the trained and validated AI models, and performing inferences associated with user requests made against these deployed AI models. Certain AI-based tasks are performed using certain specific numerical formats, which can vary across different implementations.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Various embodiments described herein control circuitry of a computing device to cause the computing device to perform an AI-based task in a numerical format different from a numerical format in which the AI-based task is received. Embodiments of the technology described herein perform certain AI-based tasks based on a programmable lookup table (PLUT) that facilitates mapping the AI-based task from a first datatype format to a second datatype format matching the datatype format of the computing device assigned to perform the AI-based task. In one embodiment, the conversion from datatypes is performed based on an instruction that includes computing logic to perform an extract operation using the PLUT. An example instruction includes a first value defining a first number of bits associated with the source register, a second value defining a start bit of source register, a third value defining a second number of bits associated with the destination register, and a fourth value defining a start bit of the destination register.

In one embodiment, a system accesses, via at least one computer processor, a task to be performed in a first datatype format. The at least one computer processor employs a different datatype format, such as a second datatype format. In one embodiment, the system accesses at least one programmable lookup table (PLUT) based on the first datatype format and the second datatype format being different. The system may use the at least one PLUT to map the task from a source register employing the first datatype format and associated with the at least one processor to a destination register employing the second datatype format and associated with the at least one processor. In one embodiment, the system performs the task based on the mapping and the at least one PLUT, as well as in accordance with the second datatype format.

By way of non-limiting example, suppose that the datatype format (in this example, the first datatype format) of the task is Floating-Point Format (FP) 4, and the datatype format (in this example, the first datatype format) associated with, hardened into, or of the processor is FP8. In this example, the target PLUT for this conversion should have 16 entries because, using equation (2) below, 2⁽⁴⁾=16, where the exponent corresponds to the bits of the datatype format of the task.

The present disclosure provides one or more technical solutions that have technical effects in light of various technical problems. Particular embodiments have the technical effect of improved lifespan and operation of hardware components by reducing inefficiencies in converting between numerical formats, for example, using the disclosed PLUT. For example, controlling circuitry in a processor causes the processor to access the PLUT to efficiently convert between datatype formats without the extensive computations performing using existing approaches. Instead, certain embodiments access a single instruction including an extract operation to perform the AI-based task using the datatype format of the AI-based task. Further, particular embodiments have the technical effect of saving power and improving computational efficiency in performing computationally expensive operations, such as those associated with performing AI-based tasks formatted in datatype formats not matching the format in which the processor executes operations. For example, certain embodiments utilize the PLUT to generate a simple instruction for enabling the processor to efficiently handle tasks in different formats, even those that are of higher precision than that employed by the processor. Additionally, certain embodiments have the technical effect of increasing scalability, allowing computing systems to enforce dozens, hundreds, thousands, or even millions of tasks, in different formats, and execute AI-based workloads, such as training, inference, and other neural network operations.

### BRIEF DESCRIPTION OF THE DRAWINGS

The present disclosure is described in detail below with reference to the attached drawing figures, wherein:

FIG. 1A is a block diagram of an example operating environment suitable for implementations of the present disclosure;

FIG. 1B depicts a block diagram of an example computing device suitable for implementations of the present disclosure;

FIG. 2 is a block diagram of an example architecture for efficiently performing a task of a workload using at least one PLUT that facilitates converting a task from one datatype format to another datatype format, in accordance with an embodiment of the present disclosure;

FIG. 3A is a block diagram of an example system including a node having discrete accelerators, in accordance with an embodiment of the present disclosure;

FIG. 3B is a block diagram of an example system including a node having a uniform baseboard (UBB) containing discrete accelerators, in accordance with an embodiment of the present disclosure;

FIG. 4 is a schematic diagram of an example programmable lookup table (PLUT), in accordance with an embodiment of the present disclosure;

FIG. 5 is a block diagram of a language model that uses a PLUT to process inputs to make particular inferences or predictions, in accordance with an embodiment of the present disclosure;

FIG. 6 depicts a flow diagram of a method for causing an artificial intelligence (AI)-based task to be performed after the AI-based task is converted, using a PLUT, from its initial, original datatype format to the datatype format of a processor, in accordance with an embodiment of the present disclosure;

FIG. 7 depicts a flow diagram of a method for causing a task to be performed after the task is converted, using a PLUT, from its initial, original datatype format to the datatype format of a processor, in accordance with an embodiment of the present disclosure;

FIG. 8 depicts a flow diagram of a method for causing an AI-based task to be performed after the AI-based task is converted using a PLUT from its initial, original datatype format to the datatype format of a processor, in accordance with an embodiment of the present disclosure;

FIG. 9 is a block diagram of an example computing environment suitable for use in implementing an embodiment of the present disclosure; and

FIG. 10 is a block diagram of an example computing device suitable for use in implementing an embodiment of the present disclosure.

### DETAILED DESCRIPTION

The subject matter of aspects of the present disclosure is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described. Each method described herein may comprise a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few.

Embodiments of the technology described herein dynamically control circuitry of a processor and/or accelerator to cause the processor to perform an AI-based task in a numerical format different from a numerical format in which the AI-based task is formatted. Embodiments of the technology described herein perform certain AI-based tasks based on a programmable lookup table (PLUT) that includes computing logic to map the AI-based task from a first datatype format to a second datatype format matching the datatype format of the processing unit (for example, a processor, a graphics processing unit [GPU], or an accelerator) that performs the AI-based task. In this manner, certain processors and/or accelerators employing certain embodiments disclosed herein, such as aspects of the PLUT, perform AI-based tasks quicker, with less power waste, and more computationally efficiency than using conventional technology.

In the context of Large Language Models (LLMs), certain specialized accelerators or processors perform AI-related tasks using weights having hundreds, thousands, or millions of parameters. Computational speed has been improved for certain AI-related tasks, such as performing inferences, by performing these AI-related tasks with “lower precision datatypes.” In one example, “lower precision datatypes” (or “narrow datatypes”) refers to data structures having numerical formats that are smaller in size and computational complexity as compared to “higher precision datatypes” (or “broad datatypes”). In the context of floating point (FP) numerical formats, example lower precision datatypes include FP 2, FP 4, FP 8, or FP 16, among others or FP values there between; and example higher precision datatypes include FP 32, FP 64, FP 128, and FP 256, among others or FP values therebetween. It should be understood that in some embodiments, certain numbers are represented using additional or alternative numerical formats other than the FP, including int2, int4, int8, int16, in32, int64, Bfloat 2, Bfloat 4, Bfloat 8, Bfloat 16, Bfloat 32, or Bfloat 64, among others.

In some instances, lower precision datatypes offer enhanced performance, quicker speed, and less power consumption than higher precision datatypes. Although higher precision datatypes are slower and consume more power than lower precision datatypes, higher precision datatypes offer higher precision and accuracy when performing complex computations. In certain instances, performing certain AI-related tasks using weights having hundreds, thousands, or millions of parameters are more quickly performed using the lower precision datatypes, such as 8 bits, 4 bits, 2 bits, and the like. As compared to higher precision datatypes, these lower precision datatypes generally offer lower precision but quicker speed and increased performance when performing AI-related tasks using weights having hundreds, thousands, or millions of parameters due to the reduced memory bandwidth utilization and reduced power consumption of these lower precision datatypes compared to broader datatypes. As a result, many AI-related tasks, such as performing inferences, are performed using lower precision datatypes.

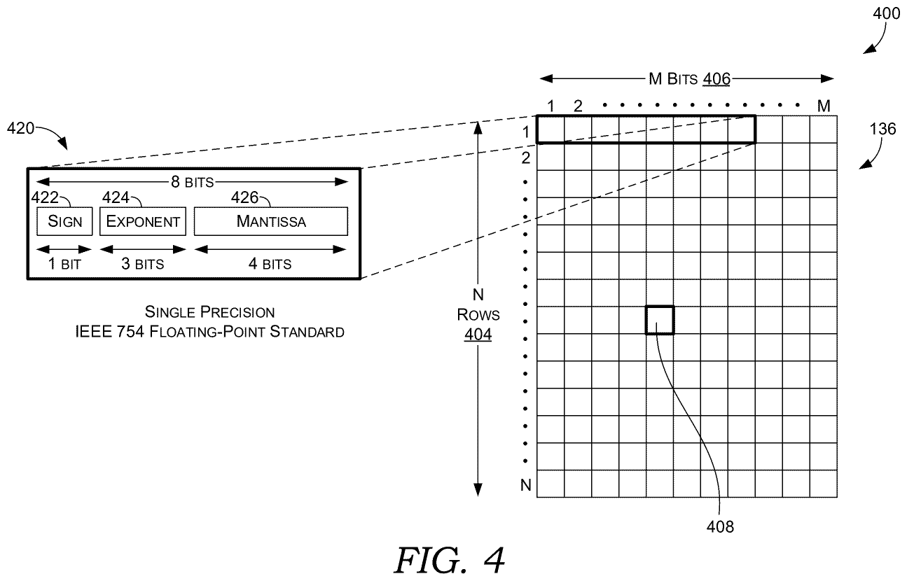

Despite the quicker computational speeds offered by processors employing these lower precision datatypes, the increased computational resource consumption associated with performing certain AI-related tasks, which are often formatted differently, has reduced computation speeds, increased power consumption, and reduced efficiency on a clock cycle-basis, the improvement of which is difficult to achieve. One way to improve computation speeds is to configure or hardwire processors to handle specific numerical formats. For example, suppose a computing device is designed with processors supporting an 8-bit floating point datatype (“FP8”) because most AI-based workloads are performing using this numerical format. Further suppose that by the time this FP8 processor is available, the technical field has evolved such that certain operations, such as AI-based tasks, have evolved to being performed as 6-bit floating point datatypes (“FP6”). In general, the FP numerical format includes three sections, namely: (1) a sign bit in a sign field, (2) exponent bits in an exponent field, and (3) mantissa bits (or significand bits) in a mantissa field (also referred to as “signficand” or a “significand field”), as illustrated in FIG. 4.

Certain existing approaches for converting from one FP datatype to another FP datatype include performing computationally expensive operations that consume power and perform extensive calculations to convert from one datatype to another datatype. For example, certain existing approaches, first, detect not-a-number values (“NaNs”) and infinity values. In one example, the NaNs are encoded with the exponent field filled with ones (like infinity values) and certain distinct non-zero numbers in the significand field to make the NaNs distinct from infinity values. Second, certain existing approaches move the sign bit from source bit location to a destination bit location. Third, certain existing approaches extract the exponent bits, remove source bias, and add the destination bias. In one example, source bias refers to the offset added to the actual exponent to get the stored exponent value, and the destination bias refers to the offset removed to the actual exponent to get the stored exponent value. For example, FP32 has a bias of 127, and FP16 has a bias of 15. In this example, converting FP16 to FP32 involves adding a bias of −15 (source bias)+127 (destination bias)=112. Fourth, certain existing approaches re-normalize the mantissa and adjust the exponent for denormal numbers, or extend the mantissa to fit in the longer mantissa length for normal numbers.

As shown by this example, certain existing approaches for converting from one datatype to another datatype involve computationally intensive operations that result in an increased power consumption by the processor, decreased lifespan for the computer chip, and a decrease in performance for certain workloads. To avoid these issues, certain existing processors continue to use higher precision datatypes for performing workloads, such as AI-based tasks, formatted in lower precision datatypes. For example, a processor employing FP8 could perform workloads formatted in FP6 because the increased memory bandwidth associated with FP8 exceeds the bandwidth consumed in performing workloads using FP6. However, this approach results in inefficient use of computational resources since employing FP8 results in the overprovisioning of resources since the same workload could be performed with less power and less computational resource consumption. Moreover, such an approach becomes dependent on ensuring that the hardware datatype precision exceeds that of the workloads. For example, if instead the workloads are formatted in FP10, the processors formatted in FP8 could not perform the workloads, resulting in certain datacenters having to wait for newer versions of the hardware supporting higher precision datatypes to be designed and released.

Another existing solution includes programming certain unary operations into certain computing devices. Example unary operations include performing transcendental functions such as exponential calculations/operations, logarithmic calculations/operations, reciprocal calculations/operations, square-root calculations/operations, sine calculations/operations, cosine calculations/operations, and the like. Programming certain unitary operations onto certain computing devices results in increased size of the processors and increased power consumption due to similar inefficient calculations as those associated with other existing approaches.

To address these and other technical issues, certain embodiments disclosed herein include employing one or more PLUTs to convert a task, such as an AI-based task, of an incoming workload from one numerical format to another numerical format. For example, certain embodiments provide computing infrastructure and logic to convert a task from a high-precision datatype to a low-precision datatype or from a low-precision datatype to a high-precision datatype. In this manner, a processor employing a datatype different than a datatype of a task to be executed by the processor can employ the task more efficiently using a format associated with the datatype of the task.

Certain embodiments include accessing a task, such as an AI-based task from a workload, such that the task is to be performed in a first datatype while the processor assigned the task is configured to perform tasks in a second datatype. If the first datatype format of the task matches the second datatype format of the processor, then certain embodiments of the processor execute the task without converting to another datatype. However, if the first datatype format of the task differs from the second datatype format, then certain embodiments access at least one PLUT. In one embodiment, the PLUT includes a two-dimensional (2D) array having N number of rows by M number of bits. Although discussed in the context of a lookup table, certain embodiments of the PLUT include any suitable data structure including enumerations (enums), hash tables, binary trees, domain/values tables, and the like for facilitating conversion between datatype formats.

In a first example, suppose that the task has FP4 as the numeric format, and the processor employs FP8 as the numerical format. In this example, the processor accesses a precision-increasing PLUT to convert the FP4 format of the task to the FP8 format of the processor. In one example, the “precision-increasing PLUT” refers to a data structure, such as a lookup table, including an array or collection of entries (of bits or bytes) to facilitate converting from a lower precision datatype to a higher precision datatype, as shown by this example.

As a second example, suppose that the task has FP16 as the numeric format, and the processor employs FP8 as the numerical format. In this example, the processor accesses a precision-decreasing PLUT to convert the FP16 format of the task to the FP16 format of the processor. In one example, the “precision-decreasing PLUT” refers to a data structure, such as a lookup table, including an array or collection of entries (of bits or bytes) to facilitate converting from a higher precision datatype to a lower precision datatype, as shown by this example.

In one embodiment, converting from one datatype format to another datatype format includes mapping the AI-based task from a source register employing the second datatype format of the processor to a destination register employing the first datatype format of the task. In one example, the “register” refers to a dedicated space in a hardware device, such as a processor or memory device. In one example, the “source register” refers to dedicated space, in the hardware device, that provides input data. In one example, “destination register” or “target register” refers to dedicated space, in the hardware device, that holds the results. In one example, the source register holds the data used in an operation (for example, arithmetic, logical, or data movement). When executing an instruction, the source register provides the input data. For example, suppose a processor is tasked with adding two numbers. In this example, one of the numbers would be in the source register associated with the processor. In one example, the destination register corresponds to storage space where the result of the operation is stored. After performing an operation (for example, the addition of two numbers), the processor outputs the result to the destination register associated with the processor.

Based on the mapping and the at least one PLUT, certain embodiments cause the AI-based task to be performed in accordance with the second datatype format. For example, after the processor uses the precision-increasing PLUT to convert the FP4 format of the task to the FP8 format of the processor, the task is executed by the processor implementing the FP8 format. As another example, after the processor uses the precision-decreasing PLUT to convert the FP16 format of the task to the FP8 format of the processor, the task is executed by the processor implementing the FP8 format. In both examples, the task is performed using the numeric format of the processor, enabling the processor to efficiently handle tasks in different formats.

The present disclosure provides one or more technical solutions that have technical effects in light of various technical problems. Particular embodiments have the technical effect of improved lifespan and operation of hardware components by reducing inefficiencies in converting between numerical formats, for example, using the disclosed PLUT. For example, controlling circuitry in a processor causes the processor to access the PLUT to efficiently convert between datatype formats without the extensive computations that are performed using certain existing approaches. Instead, certain embodiments access a single instruction an extract operation to convert between datatype formats and perform the AI-based task using the datatype format of the AI-based task. Further, particular embodiments have the technical effect of saving power and improving computational efficiency in performing computationally expensive operations, such as those associated with performing AI-based tasks formatted in datatype formats not matching the format in which the processor executes operations. For example, certain embodiments utilize the PLUT to generate a simple instruction for enabling the processor to efficiently handle tasks in different formats, even those that are of higher precision than that employed by the processor. Additionally, certain embodiments have the technical effect of increasing scalability, allowing computing systems to enforce dozens, hundreds, thousands, or even millions of tasks, in different formats, and execute AI-based workloads, such as a neural network training operation, a neural network inference operation, and other neural network operations.

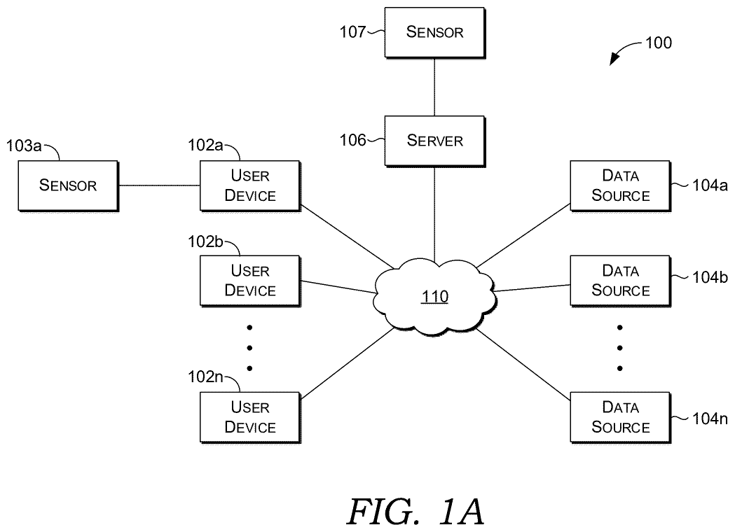

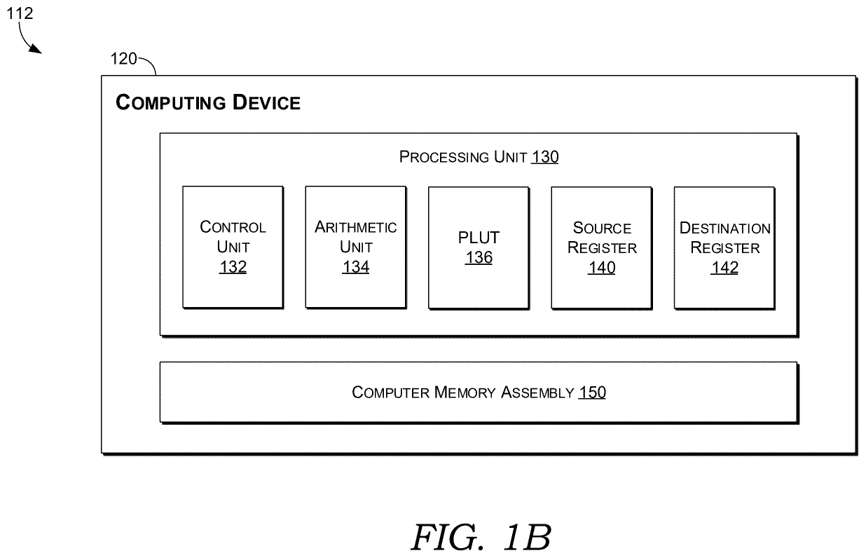

Turning now to FIG. 1A, a block diagram is provided showing an example operating environment 100 in which some embodiments of the present disclosure can be employed. It should be understood that this and other arrangements described herein are set forth only as examples. Other arrangements and elements (for example, machines, interfaces, functions, orders, and groupings of functions) can be used in addition to or instead of those shown, and some elements can be omitted altogether for the sake of clarity. Further, many of the elements described herein are functional entities that are implemented as discrete or distributed components or in conjunction with other components, and in any suitable combination and location. Various functions described herein as being performed by one or more entities are carried out by hardware, firmware, and/or software. For instance, some functions are carried out by a processor executing instructions stored in memory.

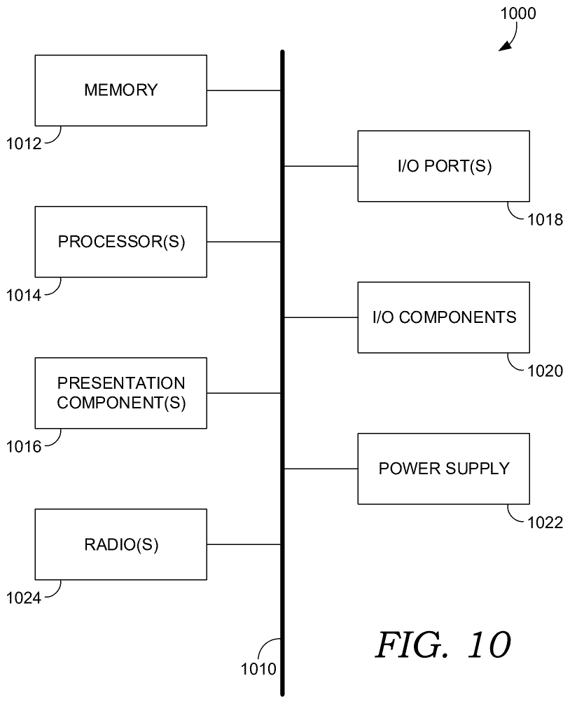

Among other components not shown, example operating environment 100 includes a number of user computing devices, such as user devices 102a and 102b through 102n; a number of data sources, such as data sources 104a and 104b through 104n; server 106; sensors 103a and 107; and network 110. It should be understood that operating environment 100 shown in FIG. 1A is an example of one suitable operating environment. Each of the components shown in FIG. 1A is implemented via any type of computing device, such as computing device 1000 illustrated in FIG. 10, for example. In one embodiment, these components communicate with each other via network 110, which includes, without limitation, one or more local area networks (LANs) and/or wide area networks (WANs). In one example, network 110 comprises the internet, intranet, and/or a cellular network, amongst any of a variety of possible public and/or private networks.

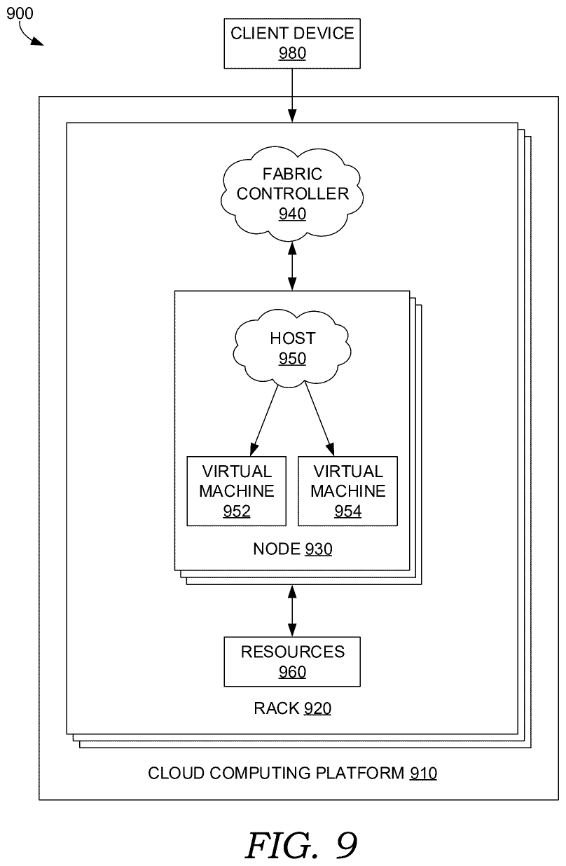

It should be understood that any number of user devices, servers, and data sources can be employed within operating environment 100 within the scope of the present disclosure. Each may comprise a single device or multiple devices cooperating in a distributed environment, such as the distributed computing environment 900 in FIG. 9. For instance, server 106 is provided via multiple devices arranged in a distributed environment that collectively provides the functionality described herein. Additionally, other components not shown may also be included within the distributed environment.

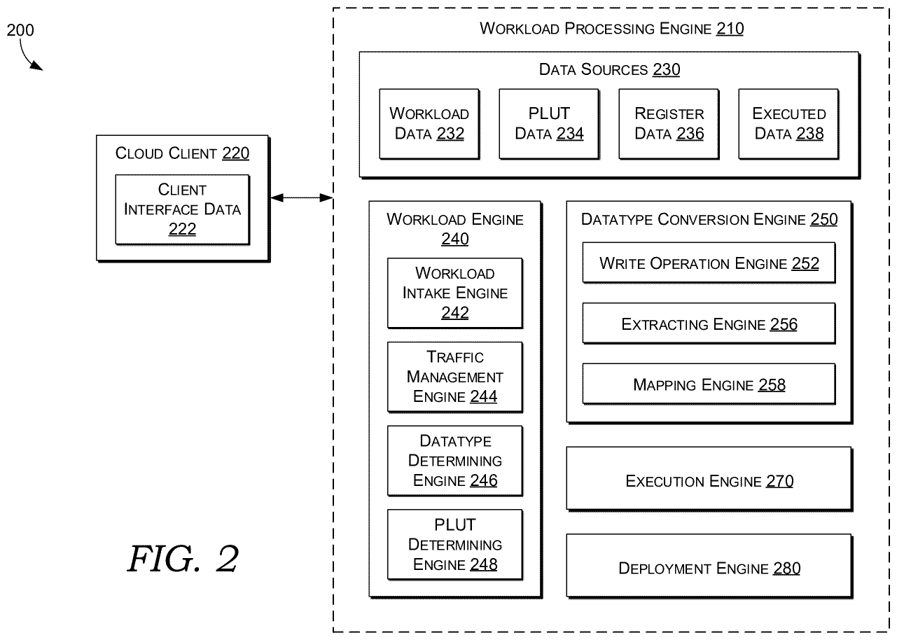

User devices 102a and 102b through 102n can be client user devices on the client-side of operating environment 100, while server 106 can be on the server-side of operating environment 100. Server 106 can comprise server-side software designed to work in conjunction with client-side software on user devices 102a and 102b through 102n so as to implement any combination of the features and functionalities discussed in the present disclosure. For example, user device 102a associated with a user account can communicate workloads over network 110 to the server 106 for processing consistently with a corresponding service-level agreement (SLA). This division of operating environment 100 is provided to illustrate one example of a suitable environment, and there is no requirement for each implementation that any combination of server 106 and user devices 102a and 102b through 102n remain as separate entities. In one embodiment, the server 106 includes certain components of systems 200, 300, 350, 400, 500, 900, and 1000 of FIGS. 2, 3A, 3B, 4, 5, 9, and 10, respectively.

In some embodiments, user devices 102a and 102b through 102n comprise any type of computing device capable of use by a user. For example, in one embodiment, user devices 102a and 102b through 102n are the type of computing device 1000 described in relation to FIG. 10. By way of example and not limitation, a user device is embodied as a personal computer (PC), a laptop computer, a mobile device, a smartphone, a smart speaker, a tablet computer, a smart watch, a wearable computer, a personal digital assistant (PDA) device, a virtual-reality (VR) or augmented-reality (AR) device or headset, music player or an MP3 player, a global positioning system (GPS) device, a video player, a handheld communication device, a gaming device or system, an entertainment system, a vehicle computer system, an embedded system controller, a camera, a remote control, an appliance, a consumer electronic device, a workstation, any other suitable computer device, or any combination of these delineated devices.

In some embodiments, data sources 104a and 104b through 104n comprise data sources and/or data systems, which are configured to make data available to any of the various constituents of operating environment 100 or systems 200, 300, 350, 400, 500, 900, and 1000 of FIGS. 2, 3A, 3B, 4, 5, 9, and 10, respectively. For instance, one or more data sources 104a and 104b through 104n provide (or make available for accessing) workload data, one or more PLUTs, register data, and any other data disclosed herein. Certain data sources 104a and 104b through 104n are discrete from user devices 102a and 102b through 102n and server 106 or are incorporated and/or integrated into at least one of those components. In one embodiment, one or more of data sources 104a and 104b through 104n comprise one or more sensors 107, which are integrated into or are associated with one or more of the user device(s) 102a and 102b through 102n or server 106. Examples of data made available by data sources 104a and 104b through 104n can include a workload data, one or more PLUTs, register data, GPU specifications, computer resource allocation parameters associated with a workload, and any other data disclosed herein.

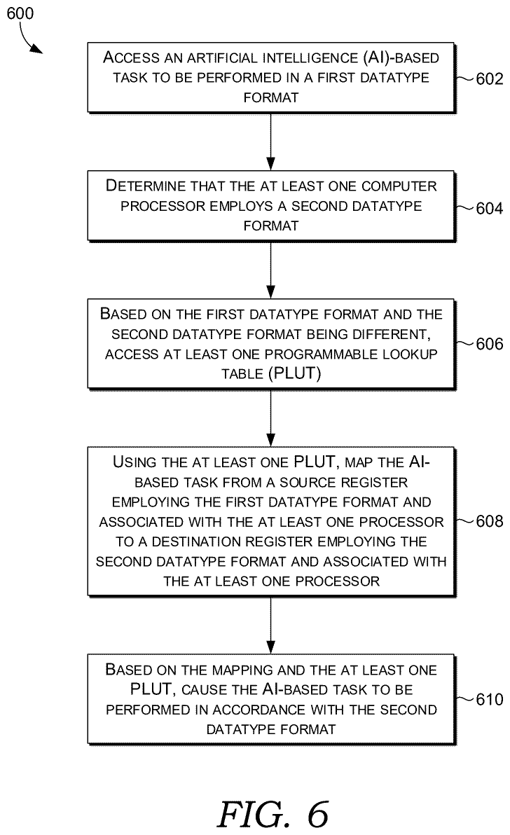

Operating environment 100 can be utilized to implement one or more of the components of systems 200, 300, 350, 400, 500, 900, and 1000 of FIGS. 2, 3A, 3B, 4, 5, 9, and 10, respectively, to perform any suitable operations. Example operations include accessing, the one or more processors, an artificial intelligence (AI)-based task to be performed in a first datatype format, such that the one or more processors employ a second datatype format; accessing, based on the first datatype format and the second datatype format being different, at least one PLUT; using the at least one PLUT, mapping the AI-based task from a source register employing the first datatype format and associated with the at least one processor to a destination register employing the second datatype format and associated with the at least one processor; and based on the mapping and the at least one PLUT, causing the AI-based task to be performed in accordance with the second datatype format. Operating environment 100 can also be utilized for implementing aspects of methods 600, 700, and 800 in FIGS. 6, 7, and 8, respectively.

FIG. 1B illustrates an example system 112 that includes a computing device 120 suitable for use in implementing aspects of the technology described herein. As illustrated, the example computing device 120 includes a processing unit 130 that includes a control unit 132, an arithmetic unit 134, a PLUT 136, a source register 140, and a destination register 142; the example computing device 120 also includes a computer memory assembly 150. The processing unit 130 includes any suitable processor such as the processor 1014 of FIG. 10.

Embodiments of the control unit 132 of the processing unit 130 include circuitry that uses electrical signals to direct the entire computing device 120 to execute stored program instructions. In one example, the control unit 132 does not directly execute program instructions; rather, the control unit 132 directs other parts of the system to do so. Embodiments of the control unit 132 communicate with both the arithmetic unit 134 and the computer memory assembly 150. The control unit 132 coordinates operations between the arithmetic unit 134, the PLUT 136, the source register 140, and the destination register 142, for example, to implement certain embodiments described herein.

Embodiments of the arithmetic unit 134 include the electronic circuitry that executes arithmetic and logical operations, such as those discussed herein, for example, by system 200 of FIG. 2. In some embodiments, the arithmetic unit 134 performs any number of arithmetic operations, or mathematical calculations, such as addition, subtraction, multiplication, and division. Additionally, in some embodiments, the arithmetic unit 134 also performs logical operations, such as comparisons of any data elements such as numbers, letters, or special characters, to name a few. Other logical operations that can be performed by the arithmetic unit 134 include, among others, equal-to operations, less-than operations, greater-than operations, less-than-or-equal-to operations, greater-than-or-equal-to operations, and not-equal operations. Thereafter, the computing device 120 can then take action based on the result of the comparison. In some embodiments, after performing a comparison operation, the computing device 120 is able to perform the restoration and other operations discussed herein. In some embodiments, the arithmetic unit 134 performs logical operations as part of a workload, for example, including AI-based tasks. In some embodiments, the arithmetic unit 134 performs logical operations using the PLUT 136.

In one example, the PLUT 136 includes a two-dimensional (2D) array having N number of rows by M number of bytes. The PLUT 136 may be stored as a lookup table in the processing unit 130 or any component accessible to the processing unit, such as the computer memory assembly 150. Although discussed in the context of a lookup table, the PLUT 136 is not limited to a table. Instead, certain embodiments of the PLUT include any suitable data structure including enumerations (enums), hash tables, binary trees, domain/values tables, and the like for facilitating conversion between datatype formats. The PLUT 136 can include at least one precision-increasing PLUT, at least one precision-decreasing PLUT, or any suitable PLUT to facilitate converting between different datatypes, as shown by this example. In one embodiment, the system 112 includes one PLUT that is reprogrammed to convert between different numeric formats. For example, in one instance, the PLUT 136 is programmed as a precision-increasing PLUT because a workload includes tasks formatted using a numerical format that is lower than that of the processing unit 130. Later, at a second instance, the PLUT 136 is reprogrammed as a precision-decreasing PLUT because a workload includes tasks formatted using a numerical format that is higher than that of the processing unit 130.

Continuing with FIG. 1B, the illustrated processing unit 130 includes a source register 140 and a destination register 142. In one example, the “source register” 140 refers to dedicated space, in the processing unit 130 or the computer memory assembly 150, that provides input data. In one example, “destination register” 142 refers to dedicated space, in the processing unit 130 or the computer memory assembly 150, that holds the results. Although illustrated within the processing unit 130, the source register 140 and the destination register 142 can be part of any component within the computing device 120 or any component external to the computing device 120.

In one example, the source register 140 holds the data used in a task (for example, arithmetic, logical, or data movement). When executing an instruction, the source register 140 provides the input data. For example, suppose the arithmetic unit 134 is tasked with adding two numbers. In this example, one of the numbers would be in the source register 140. In one example, the destination register 142 corresponds to storage space within or external to the computing device 120 where the result of the operation is stored. After performing an operation (for example, the addition of two numbers), the arithmetic unit 134 outputs the result to the destination register 142.

Embodiments of computer memory assembly 150 include at least one of: primary storage (also referred to in one example as “main memory”) and secondary storage. The processing unit 130 interacts with primary storage referring to it for both instructions and data. In the context of primary storage, embodiments of the computer memory assembly 150 hold data only temporarily while the computing device 120 executes computer-readable instructions as part of executing a program. In the context of secondary storage, embodiments of the computer memory assembly 150 hold permanent or semi-permanent data on some external magnetic or optical medium, for example. In some embodiments, the primary storage and/or the secondary storage include the source register 140 and/or the destination register 142.

With reference to FIG. 2, illustrated is an example system 200 for efficiently performing a task of a workload using at least one PLUT, in accordance with an embodiment of the present disclosure. Example system 200 includes computing logic and infrastructure for employing a workload processing engine 210 to convert a task from one numerical format to another numerical format for efficient execution by a processor, in accordance with aspects of the technology described herein. FIG. 2 includes components that correspond to components described with reference to other figures. The system 200 further includes client device 220 having client interface data 222; data sources 230 having workload data 232, PLUT data 234, register data 236, and executed data 238; the workload engine 240 having workload intake engine 242, traffic management engine 244, datatype determining engine 246, and PLUT determining engine 248; datatype conversion engine 250 having write operation engine 252, extracting engine 256, and mapping engine 258; execution engine 270; and deployment engine 280. In some embodiments, the system 200 is implemented based on certain example environments described herein to implement embodiments of the technical solution disclosed herein.

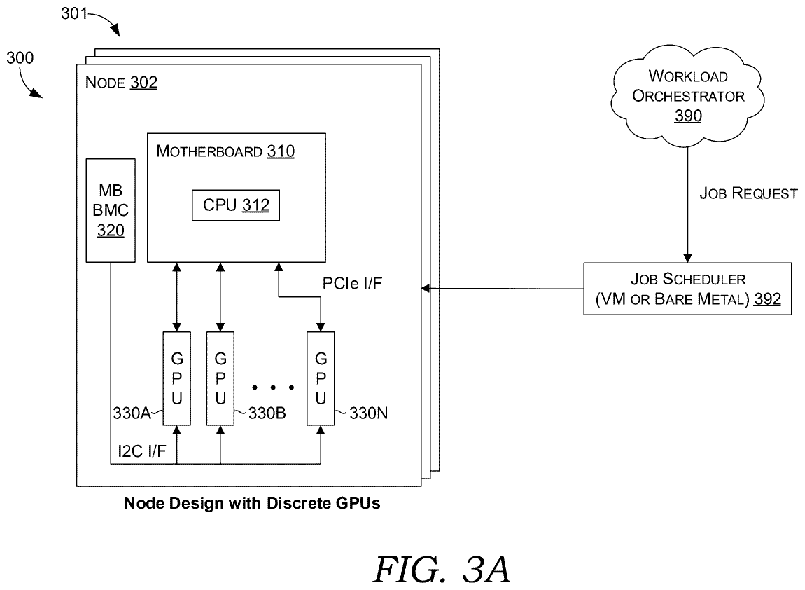

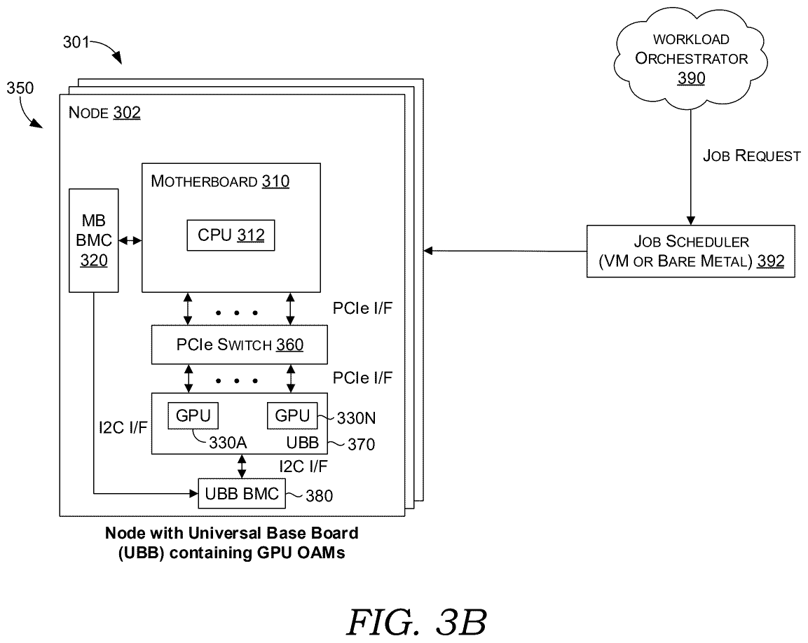

In some embodiments, the system 200 is configured to execute a task of a workload based on a mapping and at least one PLUT. In some embodiments, the system 200 includes the workload processing engine 210 that operates with management engine clients (such as the management engines of client device 220, workload orchestrator 390 of FIGS. 3A and 3B, and/or job scheduler 392 of FIGS. 3A and 3B), determines datatype formats, uses a PLUT to convert the tasks from one datatype format to another numerical format, executes the tasks based on the converted datatype format, and provides the functionality described herein. In some embodiments, the client device 220 includes client-side computing logic and instructions that complement and supplement the server-side computing logic and instructions of the workload processing engine 210 for executing the tasks of a workload using the PLUT. For example, the system 200 (1) performs operations based on a workload associated with one or more clients and (2) provides computing architecture and interfaces for accessing at least one PLUT, using the PLUT to map the task from a source register to a destination register to cause the task to match the datatype format of the processor, and executing the task based on the PLUT and the mapping, as described herein.

Workload data 232, PLUT data 234, register data 236, and executed data 238 can be stored and retrieved via data sources (e.g., data sources 230) of the system 200 and can include data that support providing the services associated with a system 200. For example, system 200 supports recording tasks received from certain clients 220 as workload data 232; maintaining up-to-date PLUTs as PLUT data 234; recording data assigned to or stored on registers, such as source registers 140 (FIG. 1B) and destination registers 142 (FIG. 1B); and recording the output of the executed task as executed data 238. Embodiments of the system 200 manage workload data 232, PLUT data 234, register data 236, and executed data 238. Additional data (e.g., metadata) associated with the workload data 232, PLUT data 234, register data 236, and executed data 238 can be tracked and stored.

With continued reference to FIG. 2, the client device 220 is communicatively coupled to the workload processing engine 210. In one embodiment, the client interface data 222 is configured to cause the client device 220 to interact with the infrastructure, components, or services provided by the workload processing engine 210. In one embodiment, the client interface data 222 includes logic to present graphical user interface (GUI) elements, with which a user may interact with, to control data associated with the client device 220. In one embodiment, the GUI elements include selectable icons, drop-down menus, scripting interfaces, text blocks, tables, and so forth. In some embodiments, the client device 220 submits control instructions for orchestrating a workload having certain tasks, such as AI-based tasks, to be executed by the workload processing engine 210. Although discussed in the context of a client device 220, system 200 may instead or additionally employ other components such as workload orchestrator 390 of FIGS. 3A and 3B, and/or job scheduler 392 of FIGS. 3A and 3B.

Continuing with FIG. 2B, certain embodiments of the workload engine 240 are configured to access workloads from the client device 220, determine tasks within the workloads, and analyze the tasks. Embodiments of the workload engine 240 determine a datatype of a task and compare the datatype of the task to the datatype format hardened into the processor. In one example, “hardened” to the processor refers to the original manufacturing specification of the processor, such that the datatype format being hardened into the processor means that the processor was designed or manufactured to process requests according to the hardened datatype format. In some embodiments, the workload engine 240 determines a PLUT to use to convert the task to the datatype format hardened into the processor.

The illustrated workload intake engine 242 of the workload engine 240 is configured with computing logic and infrastructure to receive workload data 232 defining a workload associated with a client device 220. In one embodiment, the workload intake engine 242 of the workload engine 240 is configured with computing logic to receive the workload from the client device 220 and/or from the data sources 230 as workload data 232. In one embodiment, the workload intake engine 242 of the workload engine 240 is configured with computing logic to determine a workload from a user query received from the client device 220. In one embodiment, the workload intake engine 242 translates the user query into workload data 232 and a plurality of associated tasks. For example, the client request includes a query, made via a user input into a GUI associated with the client interface data 222. The workload intake engine 242 may translate the user input into a workload. From the workload, the illustrated workload intake engine 242 determines one or more tasks. In some embodiments, the workload intake engine 242 translates the client request into a uniform format that is accessible by the other components of the workload engine 240, the datatype conversion engine 250, the execution engine 270, and/or the deployment engine 280. In some embodiments, the workload intake engine 242 accesses the tasks as Single Input, Multiple Data (SIMD).

In one embodiment, the workload intake engine 242 of the workload engine 240 is configured with computing logic to determine metadata associated with the workload from the client device 220. For example, the workload intake engine 242 determines priority information or a classification associated with the client or the workload. In one example, “priority information” refers to a predetermined or dynamically calculated value or importance of the workload. For example, a priority value of one workload or task could be higher than a priority value of another workload or task based on parameters defined in an SLA.

In some embodiments, the workload intake engine 242 determines whether the workload is associated with a particular type of workload, such as a collection of AI-based tasks. In one embodiment, the workload intake engine 242 further classifies the tasks or workload into a sub-classification. The workload may correspond to a collection of AI-based tasks, and the AI-based tasks may be further sub-classified into “inference subtasks” and “training subtasks.” The datatype determining engine 246 can access these classifications to determine a datatype associated with the task. For example, an inference task is formatted using FP4, while a training task is formatted using FP32.

In some embodiments, the traffic management engine 244 of the workload engine 240 is configured with computing logic to service client requests and direct the client requests to appropriate processors based on a traffic-routing method. In one embodiment, the traffic management engine 244 directs a task determined by the workload intake engine 242 to a target processor.

In one embodiment, the traffic management engine 244 processes client requests based on a traffic-routing method indicative of a priority level of the processor and/or the task. For example, the traffic management engine 244 receives the priority information of the workload. In one example, the priority information received from the workload intake engine 242 includes the priority level, or, in some embodiments, the workload intake engine 242 determines the priority level from the priority information. In this manner, the traffic management engine 244 can process the workloads based on the priority level associated with the workload or tasks. For example, the traffic management engine 244 accesses a service-level agreement (SLA) defining a priority of the workloads or associated requesting accounts/user device. In this example, the traffic management engine 244 assigns tasks to processors for execution, such that tasks having a higher priority level are assigned for performance before tasks having a lower priority level. Alternatively, in one example, traffic management engine 244 assigns to the processor tasks having a lower priority level before assigning tasks having a higher priority level.

In one embodiment, the traffic management engine 244 orders tasks for processing based on a traffic-routing method indicative of a level of similarity of the datatype of the task to the datatype of the processor. For example, the traffic management engine 244 receives, from the datatype determining engine 246, an indication of the datatype of the tasks and an indication of the datatype of the processor. Thereafter, in this example, the traffic management engine 244 determines which task datatype is most similar (or closest to) the datatype of the processor. For example, suppose that a processor is hardened to process workloads using FP 8. Further suppose a first task is formatted using FP 6, and a second task is formatted using FP 4. Because FP6 (in this example, the datatype format of the first task) is closer to FP 8 (in this example, the datatype format of the processor) than FP 4 (in this example, the datatype format of the second task), the traffic management engine 244 orders the first task to be performed before the second task.

Continuing with FIG. 2B, in some embodiments, the datatype determining engine 246 of the workload engine 240 is configured with computing logic to determine a datatype format of at least one task and of at least one processor. In one embodiment, the datatype determining engine 246 accesses the workload data 232 and determines metadata (or other data of a task contained in the workload). From the workload data or the metadata, the datatype determining engine 246 determines the datatype format of the task. In one embodiment, the datatype determining engine 246 determines the datatype format of the task by writing the task to a source register 140 (FIG. 1B). After the task is written to the source register 140, the datatype determining engine 246 determines the number of bits written to the source register 140. In one example, the number of bits corresponds to the datatype format of the task.

In some embodiments, the datatype determining engine 246 determines the datatype format of the processor. For example, the datatype determining engine 246 accesses the specification of the processor from the data sources 230 to determine the datatype format of the processor. In some embodiments, the datatype of the processor is hardened (or designed) into the processor, such that the processor includes circuitry to execute tasks in a particular datatype format. In one example, the datatype determining engine 246 accesses, from data sources 230, a transaction log containing prior tasks executed by the processor. From this transaction log, the datatype determining engine 246 may determine the datatype format of the processor.

Continuing with FIG. 2B, in some embodiments, the PLUT determining engine 248 of the workload engine 240 is configured with computing logic to determine a PLUT 136 (FIG. 1B) associated with the datatype format of the task and the datatype format of the processor. Embodiments of the PLUT determining engine 248 access PLUT data 234 defining one or more existing PLUTs 136 to use for converting the datatype format of the task to match the datatype format of the processor.

In one embodiment, the PLUT determining engine 248 accesses a precision-increasing PLUT when the task is formatted using a lower precision datatype format than a higher precision datatype format of the processor. For example, suppose that the task has FP4 as the numeric format, and the processor employs FP8 as the numerical format. In this example, the PLUT determining engine 248 accesses a precision-increasing PLUT to convert the FP4 format of the task to the FP8 format of the processor. In one embodiment, the PLUT determining engine 248 accesses a precision-decreasing PLUT when the task is formatted using a higher precision datatype format than a lower precision datatype format of the processor. For example, suppose that the task has FP16 as the numeric format, and the processor employs FP8 as the numerical format. In this example, the PLUT determining engine 248 accesses a precision-decreasing PLUT to convert the FP16 format of the task to the FP8 format of the processor.

Continuing with FIG. 2B, in some embodiments, the datatype conversion engine 250 is configured with computing logic to convert the datatype format of the task to the datatype of the processor based on the PLUT. In one embodiment, the datatype conversion engine 250 accesses the datatype formats of the task and associated processor from the datatype determining engine 246. In one embodiment, the datatype conversion engine 250 accesses the at least one PLUT 136 determined by PLUT determining engine 248. Using the at least one PLUT 136 determined by PLUT determining engine 248, embodiments of the datatype conversion engine 250 write at least one instruction that is consumed by the processor to perform the task using the datatype format of the processor instead of the datatype format of the task as it was received by workload engine 240. The illustrated datatype conversion engine 250 includes a write operation engine 252, an extracting engine 256, and a mapping engine 258.

In some embodiments, the datatype conversion engine 250 accesses a first PLUT to convert the task from a first datatype format to a second datatype format. Thereafter, to revert the changes of the conversion for subsequent tasks, the datatype conversion engine 250 accesses a second PLUT to convert datatype formats. Alternatively, the datatype conversion engine 250 can reprogram the PLUT to allow for another datatype conversion. In this manner, either one PLUT or a plurality of PLUTs can be employed to achieve the technical effects described herein.

In one embodiment, the datatype conversion engine 250 reprograms one PLUT 136 based on the datatype formats determined by the datatype determining engine 246. For example, suppose that the task has FP16 as the numeric format, and the processor employs FP8 as the numerical format. Further suppose that the one PLUT 136 is configured to convert from FP2 to FP8. To facilitate converting the task from FP16 to FP8, the datatype conversion engine 250 reprograms the one PLUT 136 from being able to convert from FP2 to FP8 to being able to convert from FP16 to FP8.

Embodiments of the write operation engine 252 are configured with computing logic to perform a write operation on a source register 140 (FIG. 1) or to perform a write operation that populates the PLUT with the converted data. In some embodiments, the write operation engine 252 writes the task accessed from the workload intake engine 242 as register data 236. In one embodiment, the write operation engine 252 writes the task to a source register 140 (FIG. 1). In some embodiments, the write operation engine 252 accesses the PLUT 136 from PLUT determining engine 248. The write operation engine 252 may populate entries of the PLUT with numerical representations of the task. One example computer instruction in Investigation/Study/Array (ISA) format includes “wplut i2, 23.” This example computer instruction, when executed by the processor, causes the processor to read register i2 corresponding to the task formatted according to the datatype of the task as it is received by workload engine 240 and populate index 23 of the PLUT 136.

In one embodiment, the write instruction is used before the program execution to populate the PLUT with converted datatype. For example, suppose the workload engine 240 determines that the datatype format should be converted from FP4 to FP8. In this example, the write instruction populates FP8 values for the corresponding FP4 indices (for example, 0 to 15).

In some embodiments, register data 236 includes (1) data, such as a task written to the source register 140; and/or (2) data, such as an output of the task written to destination register 142. In one embodiment, the register data 236 includes metadata associated with the source register 140 and/or the destination register 142, including, but not limited to, the processor, hardware, or computing device associated with the source register 140 and/or the destination register 142, the time stamp during which content was recorded to the source register 140 and/or the destination register 142, the datatype format associated with content recorded to the source register 140 and/or the destination register 142, and the like.

Embodiments of the extracting engine 256 are configured with computing logic to perform an extract operation. In one embodiment, the extracting engine 256 performs an extract operation on the source register to which the task is written to, for example, by write operation engine 252 or workload intake engine 242. In some embodiments, the extracting engine 256 performs the extract operation by extracting a respective number of bits (also referred to as “M” number of bits) from the source register starting at a first initial bit (also referred to as the “N'th” bit) of the source register; indexing the PLUT 136; and removing results with target bits (also referred to as “O” number of bits) from the destination register starting from a second initial bit (also referred to as the “P′th” bit) of the destination register. In some embodiments, the extracting engine 256 performs the extraction operation based on an instruction generated by the write operation engine 252 or the mapping engine 258.

In some embodiments, the extracting engine 256 generates and executes a single instruction. Take the following line of code or instruction as an example: “vbex.plut v2, v1, i1.” In this example, “vbex” is a portion of the instruction extracts bits from the source register and indexes the PLUT. More details on this example are provided below.

Embodiments of the mapping engine 258 are configured with computing logic to perform the write operation from the operation engine 252 and the extract operation from the extracting engine 256 as at least one instruction. In one embodiment, the mapping engine 258 generates a single instruction comprising the write operation and the extract operation.

By way of example, suppose that the mapping engine 258 generates an example computer instruction having the following ISA convention: “vbex.plut v2, v1, i1,” where, v2 is indicative of the destination register 142, v1 is indicative of the source register 140, and i1 is indicative of a scalar register holding values M, N, O, and P, for example, in packed format. This example computer instruction can be stored as register data 236 in data sources 230. In this example, the destination register v2 corresponds to a vector array, and the source vector v1 corresponds to a vector array holding workload data 232 associated with the task. The workload data 232 held by the source vector v1 can include Single Input, Multiple Data (SIMD). In one example, the scalar register is separate from the source register 140 and the destination register v2.

With reference to the scalar register, in one embodiment, the values M, N, O, and P held by the scaler register holding are defined as follows: M corresponds to a value (for example, scalar value) defining the number of bits associated with the source register 140, N corresponds to a value (for example, scalar value) defining the start bits of source register 140, O corresponds to a value (for example, scalar value) defining the number of bits associated with the destination register 142, and P corresponds to a value (for example, scalar value) defining the start bits of the destination register 142.

Continuing the example format using the M, N, O, and P convention of the scalar register, suppose that the task received by the workload engine 240 is formatted using FP4 and the processor executed tasks using FP8 as determined by the datatype determining engine 246. In this example, the write operation engine populates entries of the PLUT 136, which in the example above correspond to the PLUT associated with performing a conversion from FP4 datatype format to FP8 datatype format. For example, the write instruction “wpluti2, 23” reads register i2 and populates index 23 of the PLUT associated with performing a conversion from FP4 datatype format to FP8 datatype format.

Based on the datatype format of the task (for example, FP4), the datatype format of the processor (for example, FP8), and/or the write instructions, the mapping engine 258 can employ the example M, N, O, and P convention. In this example, the mapping engine 258 generates the following scalar values for M, N, O, and P: M=4, N=0, O=8, and P=0. Therefore, mapping engine 258 indicates that, as indicated by M, 4 is the number of bits associated with the source register 140; as indicated by N, 0 is the start bit of source register 140; as indicated by O, 8 is the number of bits associated with the destination register 142; and as indicated by P, 0 is the start bit of the destination register 142. Continuing with the following mapping computer instruction: “vbex.plut v2, v1, i1,” where i1=[4 0 8 0] utilizes the PLUT to map from a source register to a destination register to convert FP4 to FP8, this computer instruction generated by mapping engine 258 is passed to execution engine 270 to cause the task to be reformatted as the datatype format of the processor.

Embodiments of the execution engine 270 are configured with computing logic to perform the task received from workload engine 240 using PLUT from PLUT determining engine 248 and the register data 236 generated by datatype conversion engine 250. In this manner, the task is reformatted to the datatype format of the processor for efficient execution of the execution engine 270. In one embodiment, the execution engine 270 accesses the task from workload engine 240 and/or the mapping computer instruction from the datatype conversion engine 250. Continuing with the following mapping computer instruction: “vbex.plut v2, v1, i1,” the execution engine 270 executes this computer instruction to perform the task (originally formatted in a datatype of a different form than that of a processor) in the format of the processor. In one embodiment, the output of the execution engine is output as executed data 238 for storage in the data sources 230. For example, if the task included an AI-based task such as performing an inference, the inference, such as a classification, prediction, or the like, is saved as executed data 238 in data sources 230. As another example, if the task included an AI-based task such as performing training; the output, such as a labeling; a normalization; a validation; or the like, is saved as executed data 238 in data sources 230.

Embodiments of the deployment engine 280 are configured with computing logic to transmit or communicate the output of the task. In some embodiments, the deployment engine 280 accesses outputs from the components of system 200 or other data stored in data sources 230. In one example, the deployment engine 280 transmits the accessed output or data to any suitable device, such as the client device 220. In some embodiments, the deployment engine 280 configures the transmitted data for efficient presentation on a client device. For example, the deployment engine 280 interfaces with one or more applications or services on a device, such as the client device 220, or across multiple user devices or in the cloud. For example, the deployment engine 280 manages the presentation of the task executed in the datatype format of the processor across multiple user devices associated with that user, which the user accesses via a mobile device, laptop, or VR headset, and so forth.

Referring now to FIG. 3A, depicted is a block diagram of an example system 300 including a node 302, in accordance with an embodiment of the present disclosure. As illustrated, the system 300 includes a rack 301 including any number of nodes 302. As illustrated, the node 302 includes a motherboard 310 having a central processing unit (CPU) 312; a motherboard (MB) baseboard management controller (BMC) 320; and discrete accelerators, such as the illustrated GPUs 330A and 330B through 330N. In one embodiment, the node 302 refers to an individual self-contained server unit within the rack 301. In one example, the node 302 runs applications, processes data, and performs various tasks. Certain nodes 302 vary in terms of processing power, memory, storage, and other specifications. In a data center, nodes 302 can be organized into a cluster or network to collectively handle the computational and storage needs of applications. In one embodiment, node 302 corresponds to node 930 of FIG. 9.

In one example, the mother board (MB) BMC 320 corresponds to a controller that monitors the operating parameters of the node and determines whether the operating parameters are within or outside of a target range. An example operating parameter includes power consumption or computational efficiency associated with different tasks of different datatype formats being processed. In some embodiments, the MB BMC 320 directly communicates control signals to the GPUs to control the GPUs' execution of a workload by using the PLUT 136 (FIG. 1). In another example, the MB BMC 320 communicates the control signals to the motherboard 310, causing the motherboard 310 to control the execution of a workload by using the PLUT 136.

In one example, a “rack,” “server rack,” or “data center rack” refers to an assembly of multiple nodes 302 or servers, each with its own motherboard 310. The nodes 302 within the rack 301 work together to deliver the computational power and services for large-scale data center operations. The arrangement of nodes 302 in the rack 301 can vary depending on the specific needs and configurations of the data center. In one example, the “motherboard” refers to the main circuit board of the node 302 and includes a CPU 312, a memory (such as that illustrated in FIGS. 9 and 10), and other components that enable the node 302 to function. The motherboard serves as the central hub for connecting all the hardware components within a server. The motherboard can provide various interfaces and connectors for networking, storage, and expansion options, thereby connecting and facilitating communication between all the server's parts.

In some embodiments, the node 302 runs and implements artificial intelligence (AI) and machine learning (ML) based on workloads submitted by user devices via corresponding applications, and processed using the embodiments (for example, the PLUT) described herein. Although the illustrated embodiments include GPUs 330A and 330B through 330N, in one embodiment, nodes 302 that run these AI and ML workloads have 4 accelerators, 8 accelerators, 16 accelerators, 64 accelerators, or any suitable number of accelerators.

To facilitate controlling the GPUs 330, the node 302 employs any suitable interface connecting the motherboard 310 to the GPUs 330. In a first non-limiting example, the node 302 employs Peripheral Component Interconnect Express (PCIe), such as PCIe Form Factor (FF) to facilitate the motherboard 310 in controlling the GPUs 330, as well as implementing the embodiments disclosed herein. In one example, the “PCIe” refers to a high-speed interface used for connecting various hardware components inside a node 302 to enable the more efficient execution of computationally intensive tasks, such as AI and ML workloads. In some instances, different generations of PCIe (for example, PCIe 3.0, PCIe 4.0, or PCIe 5.0) offer varying levels of bandwidth and performance, with certain newer versions of PCIe providing faster data transfer speeds and improved GPU performance (for example, lower latency) when paired with motherboard 310.

In a second non-limiting example, the node 302 employs Open Compute Project (OCP) Accelerator Module (OAM), such as OAM Form Factor (FF), to facilitate the motherboard 310 in controlling the GPUs 330, as well as implementing the embodiments disclosed herein. In one example, the “OAM” refers to a high-speed interface used for connecting various hardware components inside a node 302 to enable the execution of computationally intensive tasks, such as AI and ML workloads.

In one embodiment, AI or ML workloads are classified as AI training workloads, AI inference workloads, or any other classification. In one example, AI training workloads are run as higher precision datatype formats across multiple racks in a cluster to train one or more models based on training models. However, certain AI training workloads can be run across multiple clusters. On the other hand, in one example, AI inference workloads are run as lower precision datatype formats within a rack on one or more nodes 302 to perform AI-related tasks, such as predictions, classifications, and generation of content, such as text, images, video, music, sounds, and the like. In some embodiments, AI inference workloads consume less compute power than AI training workloads. It should be understood that this disclosure is not limited to AI or ML workloads, such as those described herein, because the embodiments disclosed herein facilitate performing other additional or alternative tasks, such as rendering, gaming, or other GPU-based workloads. Indeed, in some embodiments, a combination of AI or ML tasks, as well as other GPU-based workloads can be performed by the components of node 302 or the rack.

In one embodiment, one or more components of the node 302 are directly or indirectly communicatively coupled to the workload orchestrator 390, for example, via the job scheduler 392. In one example, the workload orchestrator 390 refers to distributed multitenant service, such as a software running on a hardware component, that provides unified service abstraction to run or orchestrate workloads across different customers. In one embodiment, the workload orchestrator 390 executes AI or ML workloads, such as the AI training and inference workloads discussed herein, as well as other suitable tasks. An example workload orchestrator includes Singularity or Slurm. For example, the workload orchestrator 390 creates, deploys, or monitors tasks or task execution within one or more VMs running on one or more coprocessors.

As illustrated in FIGS. 3A and 3B, the workload orchestrator 390 manages the capacity for system 300 and 350 to perform tasks, such as AI or ML workloads. In one example, the workload orchestrator 390 manages the capacity for any system, such as (among others) system 300, 350, or 1000 of FIGS. 3A, 3B, and 10, respectively, to perform AI or ML workloads. In some embodiments, the workload orchestrator 390 receives tasks or workloads, for example, from workload applications. For example, the workload orchestrator 390 receives tasks or workloads in the order they are submitted, received, or cached.

After receiving the tasks or workloads, embodiments of the workload orchestrator 390 determine any number of task parameters for the tasks. As a first example, the workload orchestrator 390 determines, for each task or at least one task, at least one parameter, such as a computational resource consumption associated with running the workload, a datatype format of the workload and the GPUs, the power consumption associated with performing the task, or any suitable parameter indicative of computational resources used to execute the task.

In some embodiments, the workload orchestrator 390 is communicatively coupled to the job scheduler 392. In one example, the job scheduler 392 refers to a computing component that monitors file movements within the systems 300 or 350, and assigns the corresponding task to a component of the node 302 for execution. For example, if a predetermined time of a task arrives or a triggering file reaches the job scheduler 392, the job scheduler 392 communicates to the node 302 a request to execute the preset task. In one embodiment, the workload orchestrator 390 communicates the task parameters (for example, the first task parameter indicative of a computational resource consumption associated with running the workload and the second task parameter indicative of a series of steps to completion) to the job scheduler 392.

In one embodiment, the job scheduler 392 receives the task parameters, and based on the task parameters, instructs the nodes 302 to create one or more virtual machine (VM) instances or Bare Metal instances. For example, the job scheduler 392 instructs the GPUs 330 of the node to run a VM instance equipped to execute a workload. As another example, the job scheduler 392 submits a request to the node 302 to create the instance (VM 952 of FIG. 9 or any other suitable tenant) for the workloads. For example, the node 302 performs Hyper-V virtualization to create one or more VMs using Hyper-V on a system running any suitable operating system, such as WINDOWS® or IOS®. In one embodiment, the instance includes at least one of the GPUs 330 allocated for the workload. In one embodiment, less computationally expensive workloads (such as AI inference, gaming, and the like) are assigned fewer GPUs 330 attached to the node 302. In another embodiment, more computationally expensive tasks (such as AI training) are assigned all the GPUs 330 in the node 302. In some embodiments, the job scheduler 392 communicates one or more tasks associated with a workload to the node 302 (for example, to the GPUs 330). In some embodiments, the node 302 directs the workloads through the various components to the GPUs 330 for execution.

With reference to FIG. 3B, illustrated is a block diagram of an example system 350 including a node 302, in accordance with an embodiment of the present disclosure. As illustrated, the system 300 includes a rack 301 including a node 302. As illustrated, the node 302 includes a motherboard 310 having a CPU 312; an MB BMC 320; a PCIe Switch 360; a universal baseboard (UBB) 370 having discrete accelerators, such as the illustrated GPUs 330A and 330B through 330N; and a UBB BMC 380. In one example, the PCIe switch 360 refers to a hardware component that manages and routes PCIe connections between various devices of system 350. In one embodiment, the PCIe switch manages device expansion, load balancing, redundancy, and bandwidth among devices connected to the motherboard 310.

In one embodiment, the UBB 370 refers to a hardware component designed to accommodate and support various types of computer-on-modules (COMs) or system-on-modules (SOMs), such as the illustrated GPUs 330A through 330N. In one embodiment, the UBB 370 provides a common interface, connectors, and peripherals that can be used with different COMs, SOMs, and GPUs 330A through 330N. Example UBBs 370 include connectors, interfaces, power management, and various input/output (I/O) options (such as universal serial bus [USB], Ethernet, high-definition multimedia interface [HDMI], general-purpose input/output [GPIO], and the like), making UBBs compatible with a range of SOMs, COMs, and/or GPUs 330A through 330N, for example, from various manufacturers. By allowing the interoperability of various SOMs, COMs, and/or GPUs 330A through 330N, the UBB 370 can facilitate the development process and promote interchangeability of processing modules while reducing the burdens for custom hardware design. In this manner, certain embodiments of the node 302 employ the UBB 370 and switch out the SOMs, COMs, and/or GPUs 330A through 330N, as needed for different workloads and applications to avoid having to design a custom baseboard for each SOM, COM, and/or GPU 330A through 330N.

In one embodiment, the UBB BMC 380 corresponds to a controller that monitors the operating parameters of the UBB 370 or the one or more GPUs 330A through 330N. As discussed herein, embodiments of the UBB BMC 380 control the execution of tasks associated with a workload and the implementation of one or more PLUTS 136 (FIG. 1B). For example, the UBB BMC 380 directly communicates control signals to the GPUs 330 to control the GPU's execution of tasks associated with a workload based on the PLUT and mapping discussed herein. In another example, the UBB BMC 380 communicates the control signals to the motherboard 310 or the PCIe switch 360 to cause the motherboard 310 or PCIe switch 360 to control the GPUs 330.

Unlike system 300, system 350 includes a node 302 having the PCIe switch 360; the UBB BMC 380; and the UBB having GPUs 330A and 330B through 330N. For example, whereas in system 300 the MB BMC 380 sends the control signals (for example, to coordinate execution of a workload based on the PLUT 136) to the GPUs 330A and 330B through 330N, in system 350, MB BMC 320 sends the control signals to the UBB BMC 380. In one embodiment, the UBB BMC 380 submits control signals to the GPUs 330A and 330B through 330N (for example, via slots or OAMs) to control the GPUs 330. In one example, submitting the control signals to the GPUs 330A and 330B through 330N includes commands for accessing at least one PLUT, using the PLUT to map the task from a source register to a destination register to cause the task to match the datatype format of the processor, and executing the task based on the PLUT and the mapping, as described herein. Example commands are directly written to the GPUs using Intelligent Platform Management Interface (IPMI) or REDFISH®. In one example, “IPMI” refers to an open, industry-standard interface that was designed for the management of server systems over a number of different types of networks. IPMI functionality includes field-replaceable unit (FRU) inventory reporting, system monitoring, logging of system events, system recovery (including system resets and power-on and power-off capabilities), and alerting, to name a few.

FIG. 4 is a schematic diagram 400 of an example programmable lookup table (PLUT) 136, in accordance with an embodiment of the present disclosure. The illustrated PLUT includes a two-dimensional (2D) array having N number of rows 404 by M number of bits 406. As illustrated, the intersection of one row 404 with one column of bits 406 defines one entry 408. In the illustrated embodiment, the PLUT 136 has N×M number of entries. In some embodiments, the PLUT 136 includes a data structure organized as a multidimensional data structure with mappings there between. In some embodiments, the PLUT 136 includes a one-dimensional data structure, such as a vector. Although discussed in the context of a lookup table, certain embodiments of the PLUT include any suitable data structure including enumerations (enums), hash tables, binary trees, domain/values tables, and the like for facilitating conversion between datatype formats.

In one embodiment, a task is defined as a bit string 420 of numbers. In the context of the FP numerical format, the bit string 420 includes three sections, namely: (1) a sign bit in a sign field 422, (2) exponent bits in exponent field 424, and (3) mantissa bits (or significand bits) in a mantissa field 426 (also referred to as “signficand” or “significand field”). In one example, the bit string 420 complies with the single precision IEEE 754 Floating-Point Standard. In some embodiments, the datatype conversion engine 250 (FIG. 2) writes the bit string 420 to the PLUT 136 as part of the conversion from a datatype format of the task to another datatype format of the processor. The illustrated bit string 420 corresponds to FP8 datatype format, such that the sign bit is 1 bit, the exponent bits are 3 bits, and the mantissa bits are 4 bits. Other FP datatype formats are possible. By way of another non-limiting example, FP 32 corresponds to a 32-bit string including a sign bit with 1 bit, exponent bits with 8 bits, and mantissa bits with 23 bits.

In some embodiments, the PLUT 136 used for the conversion is based on the size (or entries) of the PLUT 136 related to the datatype format. In one example, the number of entries of the PLUT 136 is determined based on one equation (1).

$${2}^{( X - 1 )} , \qquad ( 1 )$$

$${2}^{( X )} , \qquad ( 2 )$$

where X is the number of bits associated with the datatype format of the task. In one embodiment, equation 1 is used when the sign bit of the sign field 422 of the bit string 420 of the task is to be omitted. In one embodiment, equation 2 is used when the sign bit of the sign field 422 of the bit string 420 of the task is included.

For example, suppose that the datatype format of the task is FP4 and the datatype format associated with the processor is FP8. In this example, the PLUT determining engine 248 (FIG. 2) determines, using equation 2, that the number of entries is 16 because using equation (2), 2 (4)=16. In this example, the PLUT determining engine 248 identifies a PLUT having 16 entries, which can include a first table that is a 1×16 vector or a 16×1 vector, a second table that has dimensions 2×8 or 8×2, a third table that has dimensions 4×4, or any other data structure having any suitable dimensionality capable of holding 16 entries. In some embodiments, the PLUT 136 being a vector is computationally more efficient than a PLUT that is a table or has one dimension greater than one.

As another example, suppose that the datatype format of the task is FP8 and the datatype format associated with the processor is FP6. In this example, the PLUT determining engine 248 (FIG. 2) determines, using equation 2, that the number of entries is 256 because using equation (2), 2⁽⁸⁾=256. In this example, the PLUT determining engine 248 identifies a PLUT having 256 entries, which can include a first table that is a 1×256 vector or a 256×1 vector, a second table that has dimensions 2×128 or 128×2, a third table that has dimensions 16×16, or any other data structure having any suitable dimensionality capable of holding 256 entries.

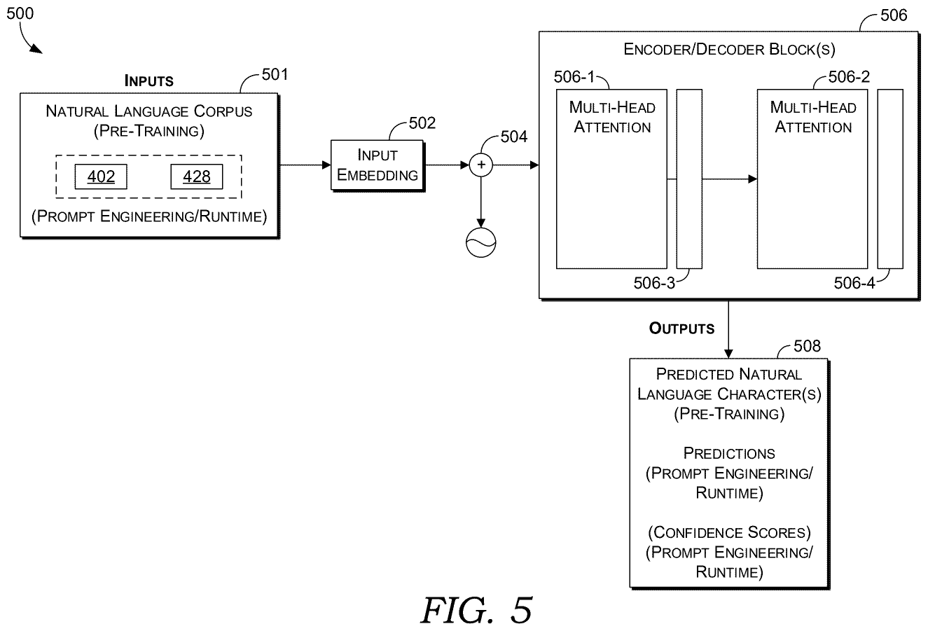

FIG. 5 is a block diagram of a language model 500 (for example, a Bidirectional Encoder Representations from Transformers [BERT] model or Generative Pre-Trained Transformer [GPT]-4 model) that uses particular inputs to make particular predictions (for example, answers to questions), according to some embodiments. Although this example illustrates a prediction operation being performed using a PLUT 136 (FIG. 1B) and as part of a task formatted using a particular datatype format and related embodiments described herein, it should be understood that the certain embodiments described herein can be implemented to perform other neural network tasks, such as inferences or training operations. In various embodiments, the language model 500 includes one or more encoders and/or decoder blocks 506 (or any transformer or portion thereof).

To illustrate, first, a natural language corpus (for example, various WIKIPEDIA English words or BooksCorpus) of the inputs 501 are converted into tokens and then feature vectors and embedded into an input embedding 502 to derive meaning of individual natural language words (for example, English semantics) during pre-training. In some embodiments, to understand English language, corpus documents, such as text books, periodicals, blogs, social media feeds, and the like, are ingested by the language model 500.

In some embodiments, each word or character in the input(s) 501 is mapped into the input embedding 502 in parallel or at the same time, unlike existing long short-term memory (LSTM) models, for example. The input embedding 502 maps a word to a feature vector representing the word. But the same word (for example, “apple”) in different sentences may have different meanings (for example, the phone versus the fruit). This is why a positional encoder 504 can be implemented. A positional encoder 504 is a vector that gives context to words (for example, “apple”) based on a position of a word in a sentence. For example, with respect to a message “I just sent the document,” because “I” is at the beginning of a sentence, embodiments can indicate a position in an embedding closer to “just,” as opposed to “document.” Some embodiments use a sine/cosine function to generate the positional encoder vector using the following two example equations:

$${PE}_{( pos , 2 i )} = sin ( pos / {10000}^{2 i / {d}_{model}} ) \qquad ( 3 )$$

$${PE}_{( pos , 2 i + 1 )} = cos ( pos / {10000}^{2 i / {d}_{model}} ) . \qquad ( 4 )$$

After passing the input(s) 501 through the input embedding 502 and applying the positional encoder 504, the output is a word embedding feature vector, which encodes positional information or context based on the positional encoder 504. These word embedding feature vectors are then passed to the encoder and/or decoder block(s) 506, where it goes through a multi-head attention layer 506-1 and a feedforward layer 506-2. The multi-head attention layer 506-1 is generally responsible for focusing or processing certain parts of the feature vectors representing specific portions of the input(s) 501 by generating attention vectors. For example, in Question-Answering systems, the multi-head attention layer 506-1 determines how relevant the i^{th} word (or particular word in a sentence) is for answering the question or how relevant it is to other words in the same or other blocks, the output of which is an attention vector. For every word, some embodiments generate an attention vector, which captures contextual relationships between other words in the same sentence or other sequences of characters. For a given word, some embodiments compute a weighted average or otherwise aggregate attention vectors of other words that contain the given word (for example, other words in the same line or block) to compute a final attention vector.

In some embodiments, a single-headed attention has abstract vectors Q, K, and V that extract different components of a particular word. These are used to compute the attention vectors for every word, using the following equation (5):

$$Z = softmax ( \frac{Q \cdot {K}^{T}}{\sqrt{Dimension of vector Q , K , or V}} ) \qquad ( 5 )$$

For multi-headed attention, there are multiple weight matrices W^{q}, W^{k}, and W^{v}, so there are multiple attention vectors Z for every word. However, a neural network may expect one attention vector per word. Accordingly, another weighted matrix, W^{z}, is used to make sure the output is still an attention vector per word. This matrix can be processed using the embodiments described herein. For example, certain embodiments employ the PLUT to cause a task in a first datatype format to be converted to a second datatype matching the datatype of the processor to cause the processor to more efficiently perform the task or an aspect of the task.

In some embodiments, after the layers 506-1 and 506-2, there is some form of normalization (for example, batch normalization and/or layer normalization) performed to smoothen out the loss surface, making it easier to optimize while using larger learning rates. Layers 506-3 and 506-4 represent residual connection and/or normalization layers where normalization recenters and rescales or normalizes the data across the feature dimensions. The feedforward layer 506-2 is a feedforward neural network that is applied to every one of the attention vectors outputted by the multi-head attention layer 506-1. The feedforward layer 506-2 transforms the attention vectors into a form that can be processed by the next encoder block or make a prediction at 508. For example, given that a document includes first natural language sequence “the due date is . . . ,” the encoder/decoder block(s) 506 predicts that the next natural language sequence will be a specific date or particular words based on past documents that include language identical or similar to the first natural language sequence.

In some embodiments, the encoder/decoder block(s) 506 includes training to learn language (pre-training) and make corresponding predictions. In some embodiments, there is no fine-tuning because some embodiments perform prompt engineering or learning. Pre-training is performed to understand language, and fine-tuning is performed to learn a specific task, such as learning an answer to a set of questions (in Question-Answering [QA] systems).

In some embodiments, the encoder/decoder block(s) 506 learns what language and context for a word is in pre-training by training on two unsupervised tasks (Masked Language Model [MLM] and Next Sentence Prediction [NSP]) simultaneously or at the same time. In terms of the inputs and outputs, at pre-training, the natural language corpus of the inputs 501 may be various historical documents, such as text books, journals, and periodicals, in order to output the predicted natural language characters in 508 (not make the predictions at runtime or prompt engineering at this point). The example encoder/decoder block(s) 506 takes in a sentence, paragraph, or sequence (for example, included in the input[s] 501), with random words being replaced with masks. The goal is to output the value or meaning of the masked tokens. For example, if a line reads, “please [MASK] this document promptly,” the prediction for the “mask” value is “send.” This helps the encoder/decoder block(s) 506 understand the bidirectional context in a sentence, paragraph, or line at a document. In the case of NSP, the encoder/decoder block(s) 506 takes, as input, two or more elements, such as sentences, lines, or paragraphs, and determines, for example, if a second sentence in a document actually follows (for example, is directly below) a first sentence in the document. This helps the encoder/decoder block(s) 506 understand the context across all the elements of a document, not just within a single element. Using both of these together, the encoder/decoder block(s) 506 derives a good understanding of natural language.

In some embodiments, during pre-training, the input to the encoder/decoder block(s) 506 is a set (for example, two) of masked sentences (sentences for which there are one or more masks), which could alternatively be partial strings or paragraphs. In some embodiments, each word is represented as a token, and some of the tokens are masked. Each token is then converted into a word embedding (for example, 502). At the output side is the binary output for the next sentence prediction. For example, this component may output 1, for example, if masked sentence 2 follows (for example, is directly beneath) masked sentence 1. The outputs are word feature vectors that correspond to the outputs for the machine learning model functionality. Thus, the number of word feature vectors that are input is the same number of word feature vectors that are output.

In some embodiments, the initial embedding (for example, the input embedding 502) is constructed from three vectors: the token embeddings, the segment or context-question embeddings, and the position embeddings. In some embodiments, the following functionality occurs in the pre-training phase. The token embeddings are the pre-trained embeddings. The segment embeddings are the sentence numbers (that includes the input[s] 501) that is encoded into a vector (for example, first sentence, second sentence, and so forth, assuming a top-down and right-to-left approach). The position embeddings are vectors that represent the position of a particular word in such a sentence that can be produced by positional encoder 504. When these three embeddings are added or concatenated together, an embedding vector is generated that is used as input into the encoder/decoder block(s) 506. The segment and position embeddings are used for temporal ordering since all of the vectors are fed into the encoder/decoder block(s) 506 simultaneously, and language models need some sort of order preserved.

In pre-training, the output is typically a binary value C (for NSP) and various word vectors (for MLM). With training, a loss (for example, cross-entropy loss) is minimized. In some embodiments, all the feature vectors are of the same size and are generated simultaneously. As such, each word vector can be passed to a fully connected layered output with the same number of neurons equal to the same number of tokens in the vocabulary.

In some embodiments, after pre-training is performed, the encoder/decoder block(s) 506 performs prompt engineering or fine-tuning on a variety of QA data sets by converting different QA formats into a unified sequence-to-sequence format. For example, some embodiments perform the QA task by adding a new question-answering head or encoder/decoder block, just the way a masked language model head is added (in pre-training) for performing an MLM task, except that the task is a part of prompt engineering or fine-tuning. This includes the encoder/decoder block(s) 506 processing the inputs 402 and/or 428, for example, by utilizing the PLUT 136 and performing corresponding mappings, as indicated in 504. Prompt engineering, in one example, is the process of crafting and optimizing text prompts for language models to achieve desired outputs. In other words, prompt engineering comprises a process of mapping prompts (for example, a question) to the output (for example, an answer) that it belongs to for training. For example, if a user asks a model to generate a poem about a person fishing on a lake, the expectation is that it will generate a different poem each time. Users may then label the output or answers from best to worst. Such labels are an input to the model to make sure the model is giving more human-like or best answers, while trying to minimize the worst answers (for example, via reinforcement learning). In some embodiments, a “prompt” as described herein includes one or more of: a request (for example, a question or instruction [for example, “write a poem”]), target content, and one or more examples, as described herein.

In some embodiments, the inputs 501 additionally or alternatively include other inputs. In one example, the predictions of the output 506 include any suitable output, such as an inference. Certain embodiments of inputs 402 and/or 428 represent inputs provided to the encoder/decoder block(s) 508 at runtime or after the model 500 has been trained, tested, and deployed. Likewise, in these embodiments, the predictions in the output 508 represent predictions made at runtime or after the model 500 has been trained, tested, and deployed.

Turning now to FIGS. 6, 7, and 8, aspects of example process flows 600, 700, and 800 are illustratively depicted for some embodiments of the disclosure. Embodiments of process flows 600, 700, and 800 each comprise a method (sometimes referred to herein as methods 600, 700, and 800) carried out to implement various example embodiments described herein. For instance, at least one of process flow 600, 700, or 800 is performed to programmatically control circuitry in a hardware component, such as a processor, to convert (using a PLUT) a task from a first datatype format of the received task to a second datatype format of the processor to cause the processor to perform the task in the second datatype format, which is used to provide any of the improved electronic technology or enhanced technical advantages, as described herein.

Each block or step of process flow 600, process flow 700, process flow 800, and other methods described herein comprises a computing process performed using any combination of hardware, firmware, and/or software. For instance, various functions are carried out by a processor or other hardware component executing instructions stored in memory, such as memory 1012 as described in FIG. 10. Embodiments of the methods can also be embodied as computer-usable instructions stored on computer storage media. Embodiments of the methods are provided by a standalone application, a service or hosted service (standalone or in combination with another hosted service), or a plug-in to another product, to name a few. For example, the blocks of process flows 600, 700, and 800 that correspond to actions (or steps) to be performed (as opposed to information to be processed or acted on) are carried out by one or more computer applications or services, in some embodiments, which operate on one or more user devices, and/or are distributed across multiple user devices, and/or servers, or by a distributed computing platform, and/or are implemented in the cloud, such as is described in connection with FIG. 9. In some embodiments, the functions performed by the blocks or steps of process flows 600, 700, and 800 are carried out by components illustrated in FIGS. 1A, 1B, 2, 3A, 3B, 4, or 5, for example.

With reference to FIG. 6, aspects of example process flow 600 are illustratively provided and provide a method for causing the AI-based task to be performed after the AI-based task is converted, using a PLUT, from its initial, original datatype format to the datatype format of a processor, in accordance with an embodiment of the present disclosure. As illustrated, at block 602, example process flow 600 includes accessing an artificial intelligence (AI)-based task to be performed in a first datatype format. At block 604, example process flow 600 includes determining that the at least one computer processor employs a second datatype format. At block 606, example process flow 600 includes accessing at least one programmable lookup table (PLUT) based on the first datatype format and the second datatype format being different. At block 608, example process flow 600 includes, using the at least one PLUT, mapping the AI-based task from a source register employing the first datatype format and associated with the at least one processor to a destination register employing the second datatype format and associated with the at least one processor. At block 610, example process flow 600 includes, based on the mapping and the at least one PLUT, causing the AI-based task to be performed in accordance with the second datatype format.

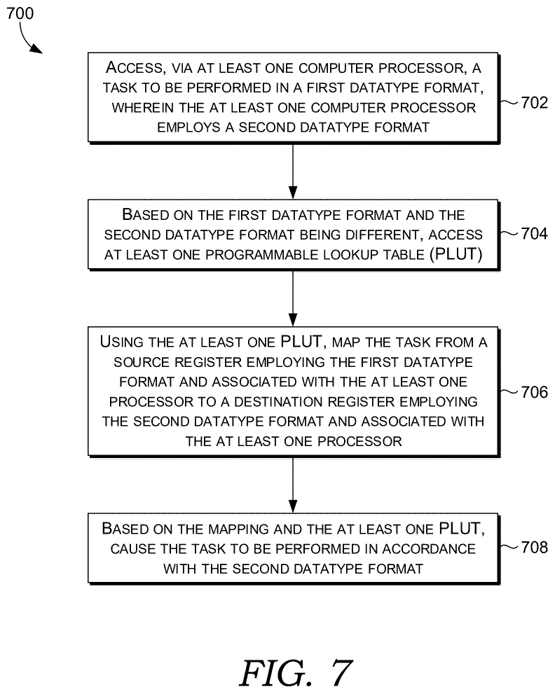

With reference to FIG. 7, aspects of example process flow 700 are illustratively provided and provide a method for causing a task to be performed after the task is converted, using a PLUT, from its initial, original datatype format to the datatype format of a processor, in accordance with an embodiment of the present disclosure. As illustrated, at block 702, example process flow 700 includes accessing, via at least one computer processor, a task to be performed in a first datatype format, wherein the at least one computer processor employs a second datatype format. As illustrated, at block 704, example process flow 700 includes accessing at least one programmable lookup table (PLUT) based on the first datatype format and the second datatype format being different. As illustrated, at block 706, example process flow 700 includes using the at least one PLUT to map the task from a source register employing the first datatype format and associated with the at least one processor to a destination register employing the second datatype format and associated with the at least one processor. As illustrated, at block 708, example process flow 700 includes, based on the mapping and the at least one PLUT, causing the task to be performed in accordance with the second datatype format.

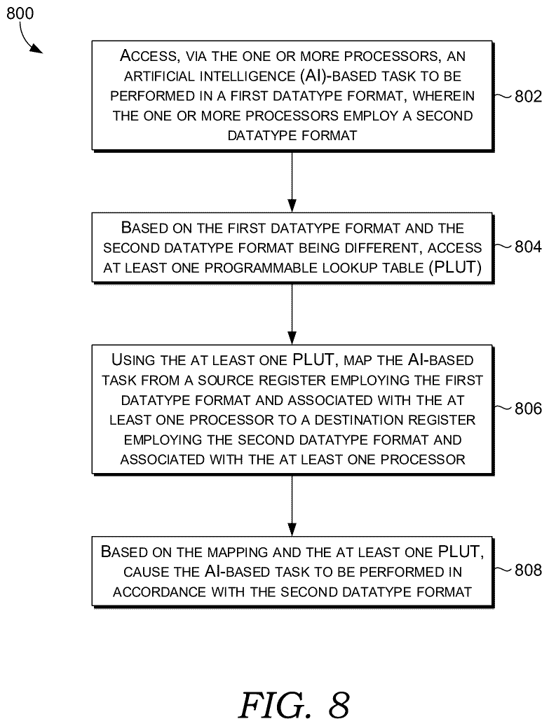

With reference to FIG. 8, aspects of example process flow 800 are illustratively provided and provide a method for causing an AI-based task to be performed after the AI-based task is converted using a PLUT from its initial, original datatype format to the datatype format of a processor, in accordance with an embodiment of the present disclosure. As illustrated, at block 802, example process flow 800 includes accessing, via the one or more processors, an artificial intelligence (AI)-based task to be performed in a first datatype format, wherein the one or more processors employ a second datatype format. As illustrated, at block 804, example process flow 800 includes accessing at least one programmable lookup table (PLUT) based on the first datatype format and the second datatype format being different. As illustrated, at block 806, example process flow 800 includes using the at least one PLUT to map the AI-based task from a source register employing the first datatype format and associated with the at least one processor to a destination register employing the second datatype format and associated with the at least one processor. As illustrated, at block 808, example process flow 800 includes, based on the mapping and the at least one PLUT, causing the AI-based task to be performed in accordance with the second datatype format.

### Other Embodiments

In some embodiments, a system, such as the computerized system described in any of the embodiments above. This system comprises at least one computer processor; and at least one computer storage media storing computer-useable instructions that, when used by the at least one computer processor, cause the system to perform operations. The example operations include accessing an artificial intelligence (AI)-based task to be performed in a first datatype format; determining that the at least one computer processor employs a second datatype format; based on the first datatype format and the second datatype format being different, accessing at least one programmable lookup table (PLUT); using the at least one PLUT, mapping the AI-based task from a source register employing the first datatype format and associated with the at least one processor to a destination register employing the second datatype format and associated with the at least one processor; and based on the mapping and the at least one PLUT, causing the AI-based task to be performed in accordance with the second datatype format.

In any combination of the above embodiments of the system, the at least one PLUT comprises at least one of: a first PLUT comprising logic to map a task from a lower precision datatype format to a higher precision datatype format; or a second PLUT comprising computing logic to map a task from the higher precision datatype format to the lower precision datatype format, such that the first PLUT or the second PLUT comprises a two-dimensional (2D) array having N number of rows by M number of bits.

In any combination of the above embodiments of the system, mapping the AI-based task from the source register to the destination register comprises, using a single instruction to perform an extract operation by: extracting a respective number of bits from the source register starting at a first initial bit of the source register; indexing the at least one PLUT; and removing results with target bits from the destination register starting from a second initial bit of the destination register.

In any combination of the above embodiments of the system, the mapping is performed based on a single instruction comprising: a first value defining a first number of bits associated with the source register; a second value defining a start bit of source register; a third value defining a second number of bits associated with the destination register; and a fourth value defining a start bit of the destination register.

In any combination of the above embodiments of the system, the first datatype format and the second datatype format respectively comprise at least one of int2, int4, int8, int16, in32, int64, Bfloat 2, Bfloat 4, Bfloat 8, Bfloat 16, Bfloat 32, Bfloat 64, floating point precision (FP) 2, FP 4, FP 8, FP 16, FP 32, FP 64, FP 128, or FP 256 numerical format.

In any combination of the above embodiments of the system, the at least one processor comprises a Single Input, Multiple Data (SIMD) processor, wherein the source register and destination register are configured to store SIMD data.

In any combination of the above embodiments of the system, mapping the AI-based task comprises: populating the at least one PLUT with entries formatted as the second datatype format; extracting one or more bits from the source register; indexing the at least one PLUT subsequent to accessing the at least one PLUT; and writing to the destination register based on the indexed PLUT.

In any combination of the above embodiments of the system, the at least one processor employs FP 8 as the second datatype format, wherein causing the AI-based task to be performed in accordance with the second datatype format comprises causing the at least one processor to perform the AI-based task by employing FP 8 as the second datatype format based on the mapping and the at least one PLUT.

In any combination of the above embodiments of the system, the operations comprise, subsequent to the AI-based task being completed, accessing a second PLUT and reverting, based on the second PLUT, the source register to the second datatype format.

In any combination of the above embodiments of the system, a number of entries in the PLUT is determined based on equation: 2^{(x-1)} or 2^{(x)}, where X is the number of bits associated with the first datatype format or the second datatype format.

Various embodiments are directed to computer-implemented methods comprising accessing, via at least one computer processor, a task to be performed in a first datatype format. The at least one computer processor may employ a second datatype format. The computer-implemented methods include, based on the first datatype format and the second datatype format being different, accessing at least one programmable lookup table (PLUT). The computer-implemented methods include, using the at least one PLUT, mapping the task from a source register employing the first datatype format and associated with the at least one processor to a destination register employing the second datatype format and associated with the at least one processor. The computer-implemented methods include, based on the mapping and the at least one PLUT, causing the task to be performed in accordance with the second datatype format.

In any combination of the above embodiments of the computer-implemented methods, the at least one PLUT comprises at least one of: a first PLUT comprising logic to map the task from a lower precision datatype format to a higher precision datatype format; or a second PLUT comprising computing logic to map the task from the higher precision datatype format to the lower precision datatype format.

In any combination of the above embodiments of the computer-implemented method, mapping the task from the source register to the destination register comprises performing an extract operation comprising: extracting a respective number of bits from the source register starting at a first initial bit of the source register; indexing the at least one PLUT; and removing results with target bits from the destination register starting from a second initial bit of the destination register.

In any combination of the above embodiments of the computer-implemented method, the at least one PLUT comprises a two-dimensional (2D) array having N number of rows by M number of bits, wherein entries in the PLUT are determined based on equation: 2^{(x-1)} or 2^{(x)}, where X is the number of bits associated with the first datatype format or the second datatype format.

In any combination of the above embodiments of the computer-implemented method, the task comprises a neural network training operation or a neural network inference operation. In some embodiments, the mapping is performed based on a single instruction comprising: a first value defining a first number of bits associated with the source register; a second value defining a start bit of source register; a third value defining a second number of bits associated with the destination register; and a fourth value defining a start bit of the destination register.

Various embodiments are directed to one or more computer storage media having computer-executable instructions embodied thereon that, when executed, by one or more processors, cause a computing system to perform operations. The operations include accessing, via the one or more processors, an artificial intelligence (AI)-based task to be performed in a first datatype format, such that the one or more processors employ a second datatype format. The operations include, based on the first datatype format and the second datatype format being different, accessing at least one programmable lookup table (PLUT). The operations include using the at least one PLUT to map the AI-based task from a source register employing the first datatype format and associated with the at least one processor to a destination register employing the second datatype format and associated with the at least one processor. The operations include, based on the mapping and the at least one PLUT, causing the AI-based task to be performed in accordance with the second datatype format.

In any combination of the above embodiments of the one or more computer storage media, the at least one PLUT comprises at least one of: a first PLUT comprising logic to map a task from a lower precision datatype format to a higher precision datatype format; or a second PLUT comprising computing logic to map a task from the higher precision datatype format to the lower precision datatype format.

In any combination of the above embodiments of the one or more computer storage media, mapping the AI-based task from the source register to the destination register comprises performing a write operation or an extract operation. For example, performing a write operation includes writing onto the source register, such that the write instruction populates entries of the PLUT with numerical representations of the AI-based task. For example, performing an extract operation comprises extracting a respective number of bits from the source register starting at a first initial bit of the source register; indexing the at least one PLUT; and removing results with target bits from the destination register starting from a second initial bit of the destination register.

In any combination of the above embodiments of the one or more computer storage media, the at least one PLUT comprises a two-dimensional (2D) array having N number of rows by M number of bits defining N by M number of entries, wherein the entries are determined based on equation: 2^{(x-1)} or 2^{(x)}, where X is the number of bits associated with the first datatype format or the second datatype format

In any combination of the above embodiments of the one or more computer storage media, wherein the AI-based task comprises a unary operation comprising at least one of an exponent operation, a logarithmic operation, a reciprocal operation, a square-root operation, a sine operation, or a cosine operation, wherein the one or more processors are manufactured for executing the unary operation in a floating point precision (FP) 2, FP 4, FP 8, or FP 16 numerical format.

### Example Computing Environments

Having described various implementations, several example computing environments suitable for implementing embodiments of the disclosure are now described, including an example computing device and an example distributed computing environment in FIGS. 9 and 10, respectively. With reference to FIG. 10, an example computing device is provided and referred to generally as computing device 1000. The computing device 1000 is but one example of a suitable computing environment and is not intended to suggest any limitation as to the scope of use or functionality of embodiments of the disclosure, and nor should the computing device 1000 be interpreted as having any dependency or requirement relating to any one or combination of components illustrated.

Embodiments of the disclosure are described in the general context of computer code or machine-useable instructions, including computer-useable or computer-executable instructions, such as program modules, being executed by a computer or other machine such as a smartphone, a tablet personal computer (PC), or other mobile device, server, or client device. Generally, program modules, including routines, programs, objects, components, data structures, and the like, refer to code that performs particular tasks or implements particular abstract datatypes. Embodiments of the disclosure are practiced in a variety of system configurations, including mobile devices, consumer electronics, general-purpose computers, more specialty computing devices, or the like. Embodiments of the disclosure are also practiced in distributed computing environments where tasks are performed by remote-processing devices that are linked through a communications network. In a distributed computing environment, program modules may be located in both local and remote computer storage media, including memory storage devices.

Some embodiments comprise an end-to-end software-based system that operates within system components described herein to operate computer hardware to provide system functionality. At a low level, hardware processors generally execute instructions selected from a machine language (also referred to as machine code or native) instruction set for a given processor. The processor recognizes the native instructions and performs corresponding low-level functions related to, for example, logic, control, and memory operations. Low-level software written in machine code can provide more complex functionality to higher level software. Accordingly, in some embodiments, computer-executable instructions include any software, including low-level software written in machine code, higher level software such as application software, and any combination thereof. In this regard, the system components can manage resources and provide services for system functionality. Any other variations and combinations thereof are contemplated within the embodiments of the present disclosure.

Referring now to FIG. 9, an example distributed computing environment 900 is illustratively provided, in which implementations of the present disclosure can be employed. In particular, FIG. 9 shows a high-level architecture of an example cloud computing platform 910 that can host a technical solution environment or a portion thereof (for example, a data trustee environment). It should be understood that this and other arrangements described herein are set forth only as examples. For example, as described above, many of the elements described herein are implemented as discrete or distributed components or in conjunction with other components, and in any suitable combination and location. Other arrangements and elements (for example, machines, interfaces, functions, orders, and groupings of functions) can be used in addition to or instead of those shown.

Data centers can support distributed computing environment 900 that includes cloud computing platform 910, rack 920, and node 930 (for example, computing devices, processing units, or blades) in rack 920. The technical solution environment can be implemented with cloud computing platform 910, which runs cloud services across different data centers and geographic regions. Cloud computing platform 910 can implement the fabric controller 940 component for provisioning and managing resource allocation, deployment, upgrade, and management of cloud services. Typically, cloud computing platform 910 acts to store data or run service applications in a distributed manner. Cloud computing platform 910 in a data center can be configured to host and support operation of endpoints of a particular service application. In one example, the cloud computing platform 910 is a public cloud, a private cloud, or a dedicated cloud.

Node 930 can be provisioned with host 950 (for example, operating system or runtime environment) running a defined software stack on node 930. In one example, a “node” refers to a physical computer system with a distinct host internet protocol (IP) address that is running one or more application servers. Node 930 can also be configured to perform specialized functionality (for example, computer nodes or storage nodes) within cloud computing platform 910. Node 930 is allocated to run one or more portions of a service application of a tenant. A tenant can refer to a customer utilizing resources of cloud computing platform 910. Service application components of cloud computing platform 910 that support a particular tenant can be referred to as a multitenant infrastructure or tenancy. The terms “service application,” “application,” or “service” are used interchangeably with regards to FIG. 9, and broadly refer to any software, or portions of software, that run on top of, or access storage and computing device locations within, a datacenter.

When more than one separate service application is being supported by nodes 930, certain nodes 930 are partitioned into virtual machines (for example, virtual machine 952 and virtual machine 954). Physical machines can also concurrently run separate service applications. The virtual machines or physical machines can be configured as individualized computing environments that are supported by resources 960 (for example, hardware resources and software resources) in cloud computing platform 910. It is contemplated that resources can be configured for specific service applications. Further, each service application may be divided into functional portions such that each functional portion is able to run on a separate virtual machine. In cloud computing platform 910, multiple servers may be used to run service applications and perform data storage operations in a cluster. In one embodiment, the servers perform data operations independently but exposed as a single device, referred to as a cluster. Each server in the cluster can be implemented as a node.

In some embodiments, client device 980 is linked to a service application in cloud computing platform 910. Client device 980 may be any type of computing device, and the client device 980 can be configured to issue commands to cloud computing platform 910. In embodiments, client device 980 communicates with service applications through a virtual Internet Protocol (IP) and load balancer or other means that direct communication requests to designated endpoints in cloud computing platform 910. Certain components of cloud computing platform 910 communicate with each other over a network (not shown), which includes, without limitation, one or more local area networks (LANs) and/or wide area networks (WANs).

With reference to FIG. 10, computing device 1000 includes a bus 1010 that directly or indirectly couples the following devices: memory 1012, one or more processors 1014, one or more presentation components 1016, one or more input/output (I/O) ports 1018, one or more I/O components 1020, and an illustrative power supply 1022. In one example, bus 1010 represents one or more buses (such as an address bus, data bus, or combination thereof). Although the various blocks of FIG. 10 are shown with lines for the sake of clarity, in reality, these blocks represent logical, not necessarily actual, components. For example, a presentation component includes a display device, such as an I/O component. Also, processors have memory. The inventors hereof recognize that such is the nature of the art and reiterate that the diagram of FIG. 10 is merely illustrative of an example computing device that can be used in connection with one or more embodiments of the present disclosure. Distinction is not made between such categories as “workstation,” “server,” “laptop,” or “handheld device,” as all are contemplated within the scope of FIG. 10 and with reference to “computing device.”

Computing device 1000 typically includes a variety of computer-readable media. Computer-readable media can be any available media that can be accessed by computing device 1000 and includes both volatile and non-volatile, removable and non-removable media. By way of example, and not limitation, computer-readable media comprises computer storage media and communication media. Computer storage media includes both volatile and non-volatile, removable and non-removable media implemented in any method or technology for storage of information such as computer-readable instructions, data structures, program modules, or other data. Computer storage media includes, but is not limited to, random-access memory (RAM), read-only memory (ROM), electrically erasable programmable read-only memory (EEPROM), flash memory or other memory technology, CD-ROM, digital versatile disks (DVDs) or other optical disk storage, magnetic cassettes, magnetic tape, magnetic disk storage or other magnetic storage devices, or any other medium that can be used to store the desired information and which can be accessed by computing device 1000. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner so as to encode information in the signal. By way of example, and not limitation, communication media includes wired media, such as a wired network or direct-wired connection, and wireless media, such as acoustic, radio frequency (RF), infrared, and other wireless media. Combinations of any of the above should also be included within the scope of computer-readable media.

Memory 1012 includes computer storage media in the form of volatile and/or non-volatile memory. In one example, the memory is removable, non-removable, or a combination thereof. Hardware devices include, for example, solid-state memory, hard drives, and optical-disc drives. Computing device 1000 includes one or more processors 1014 that read data from various entities such as memory 1012 or I/O components 1020. As used herein and in one example, the term “processor,” “processing unit,” or “a processer” refers to more than one computer processor. For example, the term processor (or “a processor”) refers to at least one processor, which may be a physical or virtual processor, such as a computer processor on a virtual machine. The term processor (or “a processor”) also may refer to a plurality of processors, each of which may be physical or virtual, such as a multiprocessor system, distributed processing or distributed computing architecture, a cloud computing system, or parallel processing by more than a single processor. Further, various operations described herein as being executed or performed by a processor are performed by more than one processor.

Presentation component(s) 1016 presents data indications to a user or other device. Presentation components include, for example, a display device, speaker, printing component, vibrating component, and the like.

The I/O ports 1018 allow computing device 1000 to be logically coupled to other devices, including I/O components 1020, some of which are built-in. Illustrative components include a microphone, joystick, game pad, satellite dish, scanner, printer, or a wireless device. The I/O components 1020 can provide a natural user interface (NUI) that processes air gestures, voice, or other physiological inputs generated by a user. In some instances, inputs are transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on the computing device 1000. In one example, the computing device 1000 is equipped with depth cameras, such as stereoscopic camera systems, infrared camera systems, red-green-blue (RGB) camera systems, and combinations of these, for gesture detection and recognition. Additionally, the computing device 1000 may be equipped with accelerometers or gyroscopes that enable detection of motion. The output of the accelerometers or gyroscopes may be provided to the display of the computing device 1000 to render immersive augmented reality or virtual reality.

Some embodiments of computing device 1000 include one or more radio(s) 1024 (or similar wireless communication components). The radio transmits and receives radio or wireless communications. Example computing device 1000 is a wireless terminal adapted to receive communications and media over various wireless networks. Computing device 1000 may communicate via wireless protocols, such as code-division multiple access (“CDMA”), Global System for Mobile (“GSM”) communication, or time-division multiple access (“TDMA”), as well as others, to communicate with other devices. In one embodiment, the radio communication is a short-range connection, a long-range connection, or a combination of both a short-range and a long-range wireless telecommunications connection. When referring to “short” and “long” types of connections, certain embodiments do not refer to the spatial relation between two devices. Instead, certain embodiments generally refer to short range and long range as different categories, or types, of connections (for example, a primary connection and a secondary connection). A short-range connection includes, by way of example and not limitation, a Wi-Fi® connection to a device (for example, mobile hotspot) that provides access to a wireless communications network, such as a wireless local area network (WLAN) connection using the 802.11 protocol; a Bluetooth connection to another computing device is a second example of a short-range connection, or a near-field communication connection. A long-range connection may include a connection using, by way of example and not limitation, one or more of code-division multiple access (CDMA), General Packet Radio Service (GPRS), Global System for Mobile Communication (GSM), time-division multiple access (TDMA), and 802.16 protocols.

Example computing devices 1000 comprise any type of computing device capable of use by a user, such as a personal computer (PC), a laptop computer, a mobile device, a smartphone, a smart speaker, a tablet computer, a smart watch, a wearable computer, a personal digital assistant (PDA) device, a virtual-reality (VR) or augmented-reality (AR) device or headset, music player or an Music Player 3 (MP3) player, a global positioning system (GPS) device, a video player, a handheld communication device, a gaming device or system, an entertainment system, a vehicle computer system, an embedded system controller, a camera, a remote control, an appliance, a consumer electronic device, a workstation, any other suitable computer device, or any combination of these delineated devices.

### Additional Structural and Functional Features of Embodiments of Technical Solution

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (for example, machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

For purposes of this disclosure, the word “including” has the same broad meaning as the word “comprising,” and the word “accessing” comprises “receiving,” “referencing,” or “retrieving.” Furthermore, the word “communicating” has the same broad meaning as the word “receiving” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

As used herein, the term “set” may be employed to refer to an ordered (i.e., sequential) or an unordered (i.e., non-sequential) collection of objects (or elements), such as machines (for example, computer devices), physical and/or logical addresses, graph nodes, graph edges, functionalities, and the like. As used herein, a set may include N elements, where N is any positive integer. That is, a set may include 1, 2, 3, . . . N objects and/or elements, where N is a positive integer with no upper bound. Therefore, as used herein, a set does not include a null set (i.e., an empty set), that includes no elements (for example, N=0 for the null set). A set may include only a single element. In other embodiments, a set may include a number of elements that is significantly greater than one, two, three, or billions of elements. A set may be an infinite set or a finite set. The objects included in some sets may be discrete objects (for example, the set of natural numbers N). The objects included in other sets may be continuous objects (for example, the set of real numbers R). In some embodiments, “a set of objects” that is not a null set of the objects may be interchangeably referred to as either “one or more objects” or “at least one object,” where the term “object” may stand for any object or element that may be included in a set. Accordingly, the phrases “one or more objects” and “at least one object” may be employed interchangeably to refer to a set of objects that is not the null or empty set of objects. A set of objects that includes at least two of the objects may be referred to as “a plurality of objects.”

As used herein and in one example, the term “subset,” is a set that is included in another set. A subset may be, but is not required to be, a proper or strict subset of the other set that the subset is included within. That is, if set B is a subset of set A, then in some embodiments, set B is a proper or strict subset of set A. In other embodiments, set B is a subset of set A, but not a proper or a strict subset of set A. For example, set A and set B may be equal sets, and set B may be referred to as a subset of set A. In such embodiments, set A may also be referred to as a subset of set B. Two sets may be disjointed sets if the intersection between the two sets is the null set.

In one example, a “workload” (also referred to herein in one example as “tasks,” “jobs,” or “workflow”) refers to a series or collection of activities or computations associated with completing a task. In one example, a “workload” is also referred to as a “job,” a “task,” a “set of jobs,” or a “set of tasks.” An example AI-based workload includes aspects of raw data processing, featurization, training, inference, and deployment. In some embodiments, the workload from user accounts is classified based on the job type and the deployment type. In one example, the job type refers to the task classification and includes any suitable classification such as “basic,” “standard,” and/or “premium,” as defined by a service-level agreement (SLA).

In one example, an “accelerator,” “processor,” or “coprocessor” can be used interchangeably to refer to a piece of hardware utilized in a data center and used to run a virtual machine and/or execute a workload that includes certain tasks, such as AI-based tasks, for example, associated with an LLM. In one example, the term “coprocessor” or “accelerator” excludes central processing units (CPUs) and includes components that work in conjunction with the CPUs, such as a graphics processing unit (GPU), a field-programmable gate array (FPGA), an application-specific integrated circuit (ASIC), a Single Input, Multiple Data (SIMD) processor, or a tensor processing unit (“TPU”), among other suitable processing hardware devices.

As used herein, the terms “application” or “app” may be employed interchangeably to refer to any software-based program, package, or product that is executable via one or more (physical or virtual) computing machines or devices. An application may be any set of software products that, when executed, provide an end user one or more computational and/or data services. In some embodiments, an application may refer to a set of applications that may be executed together to provide the one or more computational and/or data services. The applications included in a set of applications may be executed serially, in parallel, or any combination thereof. The execution of multiple applications (comprising a single application) may be interleaved. For example, an application may include a first application and a second application. An execution of the application may include the serial execution of the first and second application or a parallel execution of the first and second applications. In other embodiments, the execution of the first and second application may be interleaved.

For purposes of a detailed discussion above, embodiments of the present disclosure are described with reference to a computing device or a distributed computing environment; however, the computing device and distributed computing environment depicted herein are non-limiting examples. Moreover, the terms computer system and computing system may be used interchangeably herein, such that a computer system is not limited to a single computing device, nor does a computing system require a plurality of computing devices. Rather, various aspects of the embodiments of this disclosure may be carried out on a single computing device or a plurality of computing devices, as described herein. Additionally, components can be configured for performing novel aspects of embodiments, where the term “configured for” can refer to “programmed to” perform particular tasks or implement particular abstract datatypes using code. Further, while embodiments of the present disclosure may generally refer to the technical solution environment and the schematics described herein, it is understood that the techniques described may be extended to other implementation contexts.

Many different arrangements of the various components depicted, as well as components not shown, are possible without departing from the scope of the claims below. Embodiments of the present disclosure have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

What is claimed is:

1. A system, comprising:
at least one computer processor; and
at least one computer storage media storing computer-useable instructions that, when used by the at least one computer processor, cause the system to perform operations comprising:
accessing an artificial intelligence (AI)-based task to be performed in a first datatype format;
determining that the at least one computer processor employs a second datatype format;
based on the first datatype format and the second datatype format being different, accessing at least one programmable lookup table (PLUT);
using the at least one PLUT, mapping the AI-based task from a source register employing the first datatype format and associated with the at least one processor to a destination register employing the second datatype format and associated with the at least one processor; and
based on the mapping and the at least one PLUT, causing the AI-based task to be performed in accordance with the second datatype format.

2. The system of claim 1, wherein the at least one PLUT comprises at least one of:
a first PLUT comprising logic to map a task from a lower precision datatype format to a higher precision datatype format; or
a second PLUT comprising computing logic to map a task from the higher precision datatype format to the lower precision datatype format, wherein the first PLUT or the second PLUT comprises a two-dimensional (2D) array having N number of rows by M number of bits.

3. The system of claim 1, wherein mapping the AI-based task from the source register to the destination register comprises, using a single instruction to perform an extract operation by:
extracting a respective number of bits from the source register starting at a first initial bit of the source register;
indexing the at least one PLUT; and
removing results with target bits from the destination register starting from a second initial bit of the destination register.

4. The system of claim 1, wherein the mapping is performed based on a single instruction comprising:
a first value defining a first number of bits associated with the source register;
a second value defining a start bit of source register;
a third value defining a second number of bits associated with the destination register; and
a fourth value defining a start bit of the destination register.

5. The system of claim 1, wherein the first datatype format and the second datatype format respectively comprise at least one of int2, int4, int8, int16, in32, int64, Bfloat 2, Bfloat 4, Bfloat 8, Bfloat 16, Bfloat 32, Bfloat 64, floating point precision (FP) 2, FP 4, FP 8, FP 16, FP 32, FP 64, FP 128, or FP 256 numerical format.

6. The system of claim 1, wherein the at least one processor comprises a Single Input, Multiple Data (SIMD) processor, wherein the source register and destination register are configured to store SIMD data.

7. The system of claim 1, wherein mapping the AI-based task comprises:
populating the at least one PLUT with entries formatted as the second datatype format;
extracting one or more bits from the source register;
indexing the at least one PLUT subsequent to accessing the at least one PLUT; and
writing to the destination register based on the indexed PLUT.

8. The system of claim 1, wherein the at least one processor employs FP 8 as the second datatype format, wherein causing the AI-based task to be performed in accordance with the second datatype format comprises causing the at least one processor to perform the AI-based task by employing FP 8 as the second datatype format based on the mapping and the at least one PLUT.

9. The system of claim 1, wherein the operations comprise, subsequent to the AI-based task being completed,
accessing a second PLUT; and
based on the second PLUT, reverting the source register to the second datatype format.

10. The system of claim 1, wherein a number of entries in the PLUT is determined based on equation: 2^{(x-1)} or 2^{(x)}, where X is the number of bits associated with the first datatype format or the second datatype format.

11. A computer-implemented method, comprising:
accessing, via at least one computer processor, a task to be performed in a first datatype format, wherein the at least one computer processor employs a second datatype format;
based on the first datatype format and the second datatype format being different, accessing at least one programmable lookup table (PLUT);
using the at least one PLUT, mapping the task from a source register employing the first datatype format and associated with the at least one processor to a destination register employing the second datatype format and associated with the at least one processor; and
based on the mapping and the at least one PLUT, causing the task to be performed in accordance with the second datatype format.

12. The computer-implemented method of claim 11, wherein the at least one PLUT comprises at least one of:
a first PLUT comprising logic to map the task from a lower precision datatype format to a higher precision datatype format; or
a second PLUT comprising computing logic to map the task from the higher precision datatype format to the lower precision datatype format.

13. The computer-implemented method of claim 11, wherein mapping the task from the source register to the destination register comprises performing an extract operation comprising:
extracting a respective number of bits from the source register starting at a first initial bit of the source register;
indexing the at least one PLUT; and
removing results with target bits from the destination register starting from a second initial bit of the destination register.

14. The computer-implemented method of claim 11, wherein the at least one PLUT comprises a two-dimensional (2D) array having N number of rows by M number of bits, wherein entries in the PLUT are determined based on equation: 2^{(x-1)} or 2^{(x)}, where X is the number of bits associated with the first datatype format or the second datatype format.

15. The computer-implemented method of claim 11, wherein the task comprises a neural network training operation or a neural network inference operation, wherein the mapping is performed based on a single instruction comprising:
a first value defining a first number of bits associated with the source register;
a second value defining a start bit of source register;
a third value defining a second number of bits associated with the destination register; and
a fourth value defining a start bit of the destination register.

16. One or more computer storage media having computer-executable instructions embodied thereon that, when executed by one or more processors cause a computing system to perform operations comprising:
accessing, via the one or more processors, an artificial intelligence (AI)-based task to be performed in a first datatype format, wherein the one or more processors employ a second datatype format;
based on the first datatype format and the second datatype format being different, accessing at least one programmable lookup table (PLUT);
using the at least one PLUT, mapping the AI-based task from a source register employing the first datatype format and associated with the at least one processor to a destination register employing the second datatype format and associated with the at least one processor; and
based on the mapping and the at least one PLUT, causing the AI-based task to be performed in accordance with the second datatype format.

17. The one or more computer storage media of claim 16, wherein the at least one PLUT comprises at least one of:
a first PLUT comprising logic to map a task from a lower precision datatype format to a higher precision datatype format; or
a second PLUT comprising computing logic to map a task from the higher precision datatype format to the lower precision datatype format.

18. The one or more computer storage media of claim 16, wherein mapping the AI-based task from the source register to the destination register comprises:
performing a write operation to write onto the source register, wherein the write instruction populates entries of the PLUT with numerical representations of the AI-based task; or
performing an extract operation comprising:
extracting a respective number of bits from the source register starting at a first initial bit of the source register;
indexing the at least one PLUT; and
removing results with target bits from the destination register starting from a second initial bit of the destination register.

19. The one or more computer storage media of claim 16, wherein the at least one PLUT comprises a two-dimensional (2D) array having N number of rows by M number of bits defining N by M number of entries, wherein the entries are determined based on equation: 2^{(x-1)} or 2^{(x)}, wherein X is the number of bits associated with the first datatype format or the second datatype format.

20. The one or more computer storage media of claim 16, wherein the AI-based task comprises a unary operation comprising at least one of an exponent operation, a logarithmic operation, a reciprocal operation, a square-root operation, a sine operation, or a cosine operation, wherein the one or more processors are manufactured for executing the unary operation in a floating point precision (FP) 2, FP 4, FP 8, or FP 16 numerical format.
